(19) United States
(12) Patent Application Publication
(10) Pub. No.: US 2026/0104380 A1
(43) Pub. Date: Apr. 16, 2026

(54) GOLD-COATED MICRO-CHIP CLOZAPINE SENSOR FUNCTIONALIZED WITH CYZ NANOSHEET

(71) Applicant: KING ABDULAZIZ UNIVERSITY, Jeddah (SA)

(72) Inventors: Mohammed Muzibur RAHMAN, Jeddah (SA); Abdullah M. ASIRI, Jeddah (SA); Muhammad Tariq Saeed CHANI, Jeddah (SA); Jahir AHMED, Jeddah (SA)

(73) Assignee: KING ABDULAZIZ UNIVERSITY, Jeddah (SA)

(21) Appl. No.: 18/914,786

(22) Filed: Oct. 14, 2024

(51) Int. Cl. G01N 27/327

(52) U.S. Cl. CPC G01N 27/3278

(57) ABSTRACT

An electrochemical sensor for detecting clozapine in an analyte sample. A method of making the electrochemical sensor and a method of detecting clozapine using the electrochemical sensor. The electrochemical sensor includes a housing, a working electrode with a gold-coated microchip, a CYZ nanostructure layer, a sensing window, and a platinum counter electrode. The CYZ nanostructure layer is composed of cuprous oxide, yttrium oxide, and zinc oxide, and is disposed on the gold-coated microchip using a transparent conductive binder. The electrochemical sensor demonstrates high sensitivity, with a detection limit of 0.04 nanomoles and a linear dynamic range of 1.0 nanomoles to 1.0 micromoles. The composition and structure of the electrochemical sensor provide accurate and rapid detection of clozapine in various sample matrices, including biological fluids and pharmaceutical products, enabling the electrochemical sensor to be implemented for therapeutic drug monitoring and quality control in clozapine-based treatments.

### STATEMENT OF ACKNOWLEDGEMENT

Support provided by the Deputyship for Research & Innovation, Ministry of Education, Saudi Arabia and King Abdulaziz University, DSR Jeddah, Saudi Arabia through Project No. 2021-137 is gratefully acknowledged.

### BACKGROUND

### Technical Field

The present disclosure is directed to the field of electrochemical sensors. More specifically, the present disclosure relates to a microchip-based electrochemical sensor for detecting clozapine in biological samples and pharmaceutical products.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Electrochemical sensors play a important role in various fields, including healthcare, environmental monitoring, and pharmaceutical analysis. These sensors offer rapid, sensitive, and cost-effective methods for detecting and quantifying specific analytes in complex matrices. In healthcare systems, monitoring drug levels in the bodies of the patients is essential for ensuring proper dosage and minimizing potential side effects. This is particularly important for drugs with narrow therapeutic windows or those known to cause severe adverse reactions. Clozapine (Clz), an antipsychotic medication commonly used in the treatment of schizophrenia, falls into this category. Clozapine, while effective in treating schizophrenia, has been associated with potentially harmful side effects. As a result, its use has been limited, despite recognition that widespread use could benefit many patients. The ability to effectively monitor clozapine levels in body fluids would permit healthcare providers to adjust dosages promptly, thereby minimizing side effects and optimizing treatment outcomes.

Conventional methods for detecting and quantifying clozapine in biological samples and pharmaceutical products include capillary zone electrophoresis, high-performance liquid chromatography (HPLC), colorimetry, mass spectrometry, and spectrophotometry. However, these techniques often require expensive equipment, complex sample preparation, specialized expertise, and considerable time for analysis. Recently, the electrochemical detection of harmful chemicals by chemically modified electrodes (CMEs) has become vital due to their quick response, cheap method, handy nature, and high sensitivity, especially in situ detection. Developing an active material with better electro-catalytic activity and superior conductivity for CMEs is needed. In comparison to conventional methods that require costly and huge equipment, an electrochemical detector would be easy to use and and less expensive, with improved selectivity and higher sensitivity in a rapid response-time.

Electrochemical sensors have been proposed for Clz determination, for example, RGO nanocomposites such as gold/palladium, platinum (Au/Pd/Pt) electrodes [See: M. Senel, Z. Durmus, A. Alachkar, Measurement of the Antipsychotic Clozapine Using Reduced Graphene Oxide Nanocomposites-Au/Pd/Pt Electrodes, Electroanalysis. 33 (2021) 1585-1595], chitosan-carbon nanotube-fabricated microelectrodes [See: R. P. Shukla, C. Rapier, M. Glassman, F. Liu, D. L. Kelly, H. Ben-Yoav, An integrated electrochemical microsystemfor real—time treatment monitoring of clozapine in microliter volume samples from schizophrenia patients, Electrochem. Commun. 120 (2020) 106850], magnetic nanocomposite iron(III) oxide (Fe₃O₄)/alanine/Pd fabricated glassy carbon electrodes [See: E. Tammari, A. Nezhadali, S. Lotfi, H. Veisi, Fabrication of an electrochemical sensor based on magnetic nanocomposite Fe₃O₄/β-alanine/Pd modified glassy carbon electrode for determination of nanomolar level of clozapine in biological model and pharmaceutical samples, Sensors Actuators, B Chem. 241 (2017) 879-886], tungsten trioxide (WO₃)/GCE [See: M. R. Fathi, D. Almasifar, Electrochemical Sensor for Square Wave Voltammetric Determination of Clozapine by Glassy Carbon Electrode Modified by WO3 Nanoparticles, IEEE Sens. J. 17 (2017) 6069-6076], graphene-chitosan composites [See: M. Kang, E. Kim, T. E. Winkler, G. Banis, Y. Liu, C. A. Kitchen, D. L. Kelly, R. Ghodssi, G. F. Payne, Reliable clinical serum analysis with reusable electrochemical sensor: Toward point-of-care measurement of the antipsychotic medication clozapine, Biosens. Bioelectron. 95 (2017) 55-59], ruthenium doped titanium oxideT(iO₂) nanoparticles [See: N. P. Shetti, D. S. Nayak, S. J. Malode, R. M. Kulkarni, An electrochemical sensor for clozapine at ruthenium doped TiO2 nanoparticles modified electrode, Sensors Actuators, B Chem. 247 (2017) 858-867], catechol-chitosan composite [See: H. Ben-Yoav, S. E. Chocron, T. E. Winkler, E. Kim, D. L. Kelly, G. F. Payne, R. Ghodssi, An electrochemical micro-system for clozapine antipsychotic treatment monitoring, Electrochim. Acta. 163 (2015) 260-270], multi-walled carbon nanotubes (MWCNT)s/New Coccine doped polypyrrole [See: Ben-Yoav et al.], and ion-selective electrodes [See: A. S. Al Attas, Novel PVC membrane selective electrode for the determination of clozapine in pharmaceutical preparations, Int. J. Electrochem. Sci. 4 (2009) 9-19], electrochemically pretreated GCE [See: Al Attas et al.].

Recently, modification of electrodes by nanomaterials such as transition metal oxides and various types of nanocomposites (NCS) has become a research topic of interest. Scientists have investigated thin films composed of mixed metal oxide composites for detecting harmful chemicals. Among these metal oxides, ZnO-containing ternary metal oxides are notable nanomaterials for sensing applications. ZnO provides a suitable environment for doping various elements as a host due to its high band-gap, low phonon frequency, and good thermal and chemical stability. The incorporation of transition and rare earth metals can affect the structural and optical properties of the host materials. Multiple phosphors have been reported through doping of copper and lanthanide combinations.

Furthermore, microchips (μ-Chips) have been increasingly utilized in medicine and healthcare. The technology offers advantages including cost efficiency, low sample volumes, portability, precise results, parallelization, ergonomics, rapid diagnostics, and high sensitivity. Microchip technology is being extensively applied in point-of-care diagnostics, particularly in less-developed countries. Microchip technologies have rapidly expanded and are combined with various detection techniques suitable for high-throughput screening, including detection and mechanistic study of drugs. S. Lin et al. [See: S. Lin, W. Wang, X. J. Ju, R. Xie, Z. Liu, H. R. Yu, C. Zhang, L. Y. Chu, Ultrasensitive microchip based on smart microgel for real-time online detection of trace threat analytes, Proc. Natl. Acad. Sci. U.S.A 113 (2016) 2023-2028] reported an ultrasensitive Pb²⁺-detection platform using a microchip for real-time detection. Microchip-based detectors were reviewed by M. Muluneha and D. Issadore. Mauro Ferrari [See: M. Muluneh, D. Issadore, Microchip-based detection of magnetically labeled cancer biomarkers, Adv. Drug Deliv. Rev. 66 (2014) 101-09]. Mauro Ferrari [See: M. Ferrari, Cancer nanotechnology: Opportunities and challenges, Nat. Rev. Cancer. 5 (2005) 161-171]proposed measuring soluble blood-borne cancer biomarkers using microchip technology. The combination of nanomaterials and microchip technology presents opportunities for developing highly sensitive and selective sensors for various analytes, including pharmaceutical compounds and biomarkers.

US20230112391A1 describes an electrochemical microsensor comprising an array of working microelectrodes, which includes one or more surface modified gold electrodes coated with polysaccharide, optionally with carbon nanotubes incorporated within the coating, one or more platinum black coated electrode, and one or more graphene oxide or metal chalcogenide gold coated electrodes and a counter electrode to quantify clozapine in a capillary sample. However, this reference does not mention a ternary metal oxide nanostructure for electrode modification, and the use of polysaccharide coatings may not offer the level of sensitivity and selectivity necessary in a clozapine sensor for real-time detection.

US20230109643A1 describes an electrochemical sensor for clozapine detection including an electrochemically pretreated glassy carbon electrode, multiwall carbon nanotubes (MWCNTs)/new coccine (NC) doped polypyrrole, Fe₃O₄, Al, and palladium composite coated glassy carbon electrode and reduced-graphene oxide-modified microelectrode. A window is provided over the electrodes. However, this reference does not disclose a ternary metal oxide nanostructure for electrode modification, and relies on complex electrode modifications involving multiple materials.

“Electrochemical determination of the antipsychotic medication clozapine by a carbon paste electrode modified with a nanostructure prepared from titania nanoparticles and copper oxide” describes a clozapine sensor nanostructure made from titania nanoparticles and copper oxide (TiO₂NP@CuO) which are used to modify a carbon paste electrode. However, this reference does not mention using a ternary metal oxide nanostructure for electrode modification, and the used binary metal oxide nanostructure for modification is not able to offer level of sensitivity and selectivity necessary in a clozapine sensor for real-time detection.

Each of the aforementioned references suffers from one or more drawbacks hindering their adoption, such as limited sensitivity, complex electrode modifications, long processing time or the use of materials that may not provide optimal selectivity for clozapine detection. Accordingly, it is one object of the present disclosure to provide an electrochemical sensor for detecting clozapine in an analyte sample, comprising a combination of materials and fabricated to provide low detection limit, a wide linear dynamic range, high selectivity for clozapine in the presence of common interfering substances, rapid detection rates and be suitable for use with various biological and pharmaceutical samples, thereby overcoming the limitations of existing techniques.

### SUMMARY

In an exemplary embodiment, an electrochemical sensor for detecting clozapine in an analyte sample is described, comprising: a housing; working electrode located within the housing, wherein the working electrode comprises a gold-coated microchip; a CYZ nanostructure layer located over the gold-coated microchip, wherein the CYZ nanostructure layer comprises a nanosheet of a ternary metal oxide containing a cuprous oxide, an yttrium oxide, and a zinc oxide (Cu₂O,Y₂O₃,ZnO); a sensing window located in the housing over the working electrode, wherein the sensing window is configured to receive a liquid analyte; a platinum counter electrode configured to be immersed in the received liquid analyte; a computing device connected to the working electrode and the platinum counter electrode, wherein the computing device is configured to receive an electrical signal generated by the CYZ nanostructure layer between the working electrode and the platinum counter electrode and detect when the liquid analyte contains clozapine based on the received signal; and a display connected to the computing device, wherein the computing device is configured to generate a readout on the display when the liquid analyte contains clozapine.

In another exemplary embodiment, a method of making an electrochemical sensor for detecting clozapine in a liquid analyte is described, comprising: mixing equimolar amounts of Zn²⁺ ions, Cu²⁺ ions, Y³⁺ ions and NH₄OH in a flask; stirring the equimolar amounts for about 30 minutes while holding a temperature within the flask at about 60° C.; adding an additional amount of NH₄OH drop-wise to the flask while stirring; increasing the temperature in the flask to about 70° C. and stirring for about 6 hours until a precipitate forms; washing the precipitate with double distilled water and ethanol; drying the washed precipitate for 30 minutes at about 23° C.; growing a CYZ nanostructure by heating the dried and washed precipitate for 2 hours at about 23° C.; dissolving the CYZ nanostructure in a transparent conductive binder; depositing the dissolved CYZ nanostructure in the transparent conductive binder on a gold-coated microchip to form a CYZ nanostructure layer, the CYZ nanostructure layer comprising a nanosheet formed of cuprous oxide, yttrium oxide, zinc oxide; encasing the gold-coated microchip in a housing; forming a sensing window in the housing over the CYZ nanostructure layer, wherein the sensing window is configured to receive a liquid analyte; connecting a platinum counter electrode to a first terminal of a readout circuitry of the gold-coated microchip, wherein the platinum counter electrode is configured to be immersed in the received liquid analyte; connecting a working electrode to a second terminal of a readout circuitry of the gold-coated microchip; connecting the readout circuitry to a computing device; receiving, by the computing device, an electrical signal generated by the CYZ nanostructure layer between the working electrode and the platinum counter electrode; detecting, by the computing device, when the liquid analyte contains clozapine based on the received electrical signal; and generating, by the computing device, a readout on a display when the liquid analyte contains clozapine.

In yet another exemplary embodiment, a method of detecting clozapine in an analyte sample is described, comprising: forming a liquid analyte by mixing a biological sample with a phosphate buffer solution (PBS); injecting the liquid analyte into a sensing window of a housing configured with a gold-coated microchip functionalized by a CYZ nanostructure layer comprising a nanosheet formed of cuprous oxide, yttrium oxide and zinc oxide; receiving, by a readout circuitry connected to a platinum counter electrode and a working electrode of the gold-coated microchip functionalized by a CYZ nanostructure layer, an electrical signal generated by the presence of clozapine in the liquid analyte, wherein the platinum counter electrode is immersed in the liquid analyte; detecting, by a computing device connected to the readout circuitry, a concentration of clozapine in the liquid analyte; and displaying, on a display connected to the computing device, the concentration of clozapine in the liquid analyte.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is an exemplary diagrammatic illustration of an electrochemical sensor for detecting clozapine in an analyte sample, according to certain embodiments.

FIG. 1B is an exemplary diagrammatic illustration of a working electrode located within a housing of the electrochemical sensor, according to certain embodiments.

FIG. 1C is an exemplary diagrammatic illustration of a sensing window located in a housing over the working electrode of the electrochemical sensor, according to certain embodiments.

FIG. 2 is an exemplary schematic illustration of electrochemical oxidation mechanism of clozapine, for detection thereof, using the electrochemical sensor, according to certain embodiments.

FIG. 3 is an exemplary plot showing current response of the electrochemical sensor for various concentrations of clozapine, according to certain embodiments.

FIG. 4 is an exemplary flowchart of a method of making an electrochemical sensor for detecting clozapine in a liquid analyte, according to certain embodiments.

FIG. 5 is an exemplary flowchart of a method of detecting clozapine in an analyte sample, according to certain embodiments.

FIG. 6A is an X-ray diffraction (XRD) pattern of the CYZ nanostructure, according to certain embodiments.

FIG. 6B is a Fourier Transform Infrared (FTIR) spectrum of the CYZ nanostructure, according to certain embodiments.

FIG. 6C is a UV-Visible spectrum of the CYZ nanostructure with an inset showing Tauc plot, according to certain embodiments.

FIG. 7A is a low-resolution Field Emission Scanning Electron Microscope (FESEM) image of the CYZ nanostructure, according to certain embodiments.

FIG. 7B is a high-resolution FESEM image of the CYZ nanostructure, according to certain embodiments.

FIG. 7C is an Energy-Dispersive X-ray Spectroscopy (EDS) spectrum of the CYZ nanostructure, according to certain embodiments.

FIG. 7D is an elemental mapping derived from the EDS spectrum analysis of the CYZ nanostructure, according to certain embodiments.

FIG. 8A is a full scan X-ray Photoelectron Spectroscopy (XPS) spectrum of the CYZ nanostructure, according to certain embodiments.

FIG. 8B is a fine scan XPS spectrum of Zn-2p in the CYZ nanostructure, according to certain embodiments.

FIG. 8C is a fine scan XPS spectrum of O-1s in the CYZ nanostructure, according to certain embodiments.

FIG. 8D is a fine scan XPS spectrum of Cu-2p in the CYZ nanostructure, according to certain embodiments.

FIG. 8E is a fine scan XPS spectrum of Y-3d in the CYZ nanostructure, according to certain embodiments.

FIG. 9A is a graph illustrating a selectivity study of the electrochemical sensor for clozapine detection in the presence of ten interfering chemicals, according to certain embodiments.

FIG. 9B is a graph illustrating comparison of current responses of Au/microchip electrode and the electrochemical sensor for clozapine detection, according to certain embodiments.

FIG. 9C is a graph illustrating pH optimization study for clozapine detection using the electrochemical sensor, according to certain embodiments.

FIG. 9D is a graph illustrating current response of the electrochemical sensor with and without the presence of clozapine, according to certain embodiments.

FIG. 10A is a graph illustrating electrochemical responses of the electrochemical sensor for different clozapine concentrations ranging from 1.0 nM to 0.1 M, according to certain embodiments.

FIG. 10B is a graph illustrating calibration curve of the electrochemical sensor for clozapine detection at +0.23 V, according to certain embodiments.

FIG. 11A is a graph illustrating repeatability of the electrochemical sensor for clozapine detection, according to certain embodiments.

FIG. 11B is a graph illustrating reproducibility of the electrochemical sensor for clozapine detection, according to certain embodiments.

FIG. 11C is a graph illustrating stability of the electrochemical sensor for clozapine detection over time, according to certain embodiments.

FIG. 12 is an illustration of a non-limiting example of details of computing hardware used in a computing device, according to certain embodiments.

FIG. 13 is an exemplary schematic diagram of a data processing system used within the computing device, according to certain embodiments.

FIG. 14 is an exemplary schematic diagram of a processor used with the computing device, according to certain embodiments.

FIG. 15 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed to an electrochemical sensor for detecting clozapine in an analyte sample and related methods of manufacture and use. The electrochemical sensor utilizes a combination of materials and structures to achieve improved sensitivity, selectivity, and reliability in clozapine detection compared to existing techniques. The electrochemical sensor incorporates advanced nanomaterials and microchip technology to provide enhanced performance characteristics, including a lower detection limit and wider linear dynamic range than many existing sensors. The present disclosure provides a more accessible, rapid, and cost-effective approach to clozapine detection and quantification, leading to advancement in the field of therapeutic drug monitoring for clozapine, with potential implications for improving patient care and drug development processes.

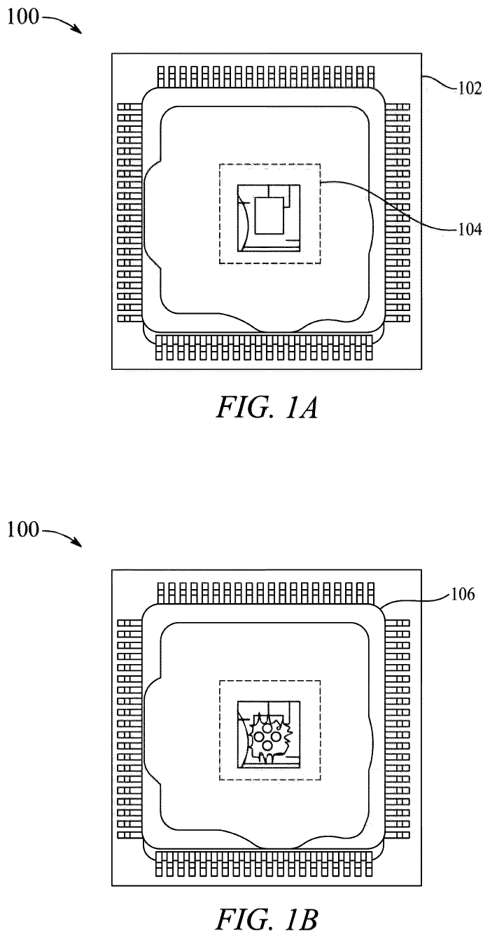

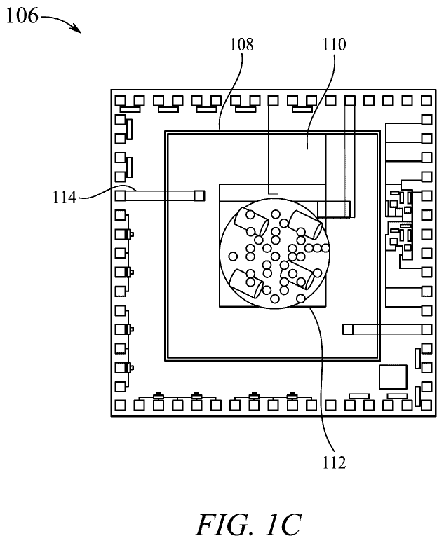

Referring to FIG. 1A, illustrated is an electrochemical sensor (as represented by reference numeral 100) for detecting clozapine in an analyte sample. The electrochemical sensor 100 is a device configured to detect and quantify clozapine in the analyte sample through electrochemical reactions. The electrochemical sensor 100 utilizes electrical conductivity and chemical properties of its components to generate a measurable electrical signal in response to the presence of clozapine, for such detection and quantification purposes. Clozapine is an antipsychotic medication commonly used in the treatment of schizophrenia. Clozapine is a tricyclic dibenzodiazepine derivative with the chemical formula C₁₈H₁₉ClN₄. In the present context, clozapine is the target analyte that the electrochemical sensor 100 is specifically designed to detect and quantify in various sample matrices.

Herein, the analyte sample refers to the liquid substance that is introduced into the electrochemical sensor 100 for analysis. The analyte sample may include biological fluids such as blood serum or urine, or pharmaceutical preparations containing clozapine. For purposes of the present disclosure, the analyte sample, provided as a liquid analyte, includes a phosphate buffer solution (PBS) mixed with a biological sample. The analyte sample is mixed with the PBS to create a suitable electrolyte medium for electrochemical detection, by the electrochemical sensor 100. The PBS also helps to maintain a stable pH environment, which is important for the reproducibility and accuracy of the clozapine detection.

As shown in FIG. 1A, the electrochemical sensor 100 includes a housing 102. The housing 102 serves as a protective enclosure for internal components of the electrochemical sensor 100. The housing 102 is depicted as a generally square structure; however, in other examples, the housing 102 may have different shape as per design requirements of the electrochemical sensor 100, without any limitations. The housing 102 generally has a compact size, which permits for potential integration of the electrochemical sensor 100 into portable devices, making it suitable for point-of-care applications and near real-time monitoring of clozapine levels. The electrochemical sensor 100 includes a working electrode 104 located within the housing 102. As depicted, the working electrode 104 is contained within a central region of the housing 102. The working electrode 104 may also have a square shape, matching the geometry of the housing 102. Such design maximizes the sensing area within the confined space of the housing 102. The housing 102 is designed to protect the working electrode 104 and other internal components from external environmental factors, while also providing a stable platform for the sensing operations.

Referring to FIG. 1B, illustrated is a detailed view of the electrochemical sensor 100. The working electrode 104 includes a gold-coated microchip 106. The gold-coated microchip 106 forms the foundation for the sensing mechanism of the electrochemical sensor 100. In particular, the gold-coated microchip 106 provides a conductive substrate onto which a sensing layer can be deposited (as discussed later). The dimensions of the gold-coated microchip 106 are designed to provide an adequate surface area for sensing while maintaining the overall compact size of the electrochemical sensor 100. In an example, the gold-coated microchip 106 may have dimensions of about 5 millimeters×5 millimeters. It may be appreciated that gold coating in the gold-coated microchip 106 enhances conductivity and electrochemical properties of the working electrode 104. In an example, the gold coating may be applied to the microchip using techniques such as physical vapor deposition or electroplating to ensure uniform coverage. Further, the microchip format facilitates miniaturization of the electrochemical sensor 100, permitting the use of small sample volumes for testing.

Referring to FIG. 1C, illustrated is a detailed view of the gold-coated microchip 106. As shown, the electrochemical sensor 100 includes a CYZ nanostructure layer 108 located over the gold-coated microchip 106. The CYZ nanostructure layer 108 includes a nanosheet of a ternary metal oxide containing cuprous oxide (Cu₂O), yttrium oxide (Y₂O₃), and zinc oxide (ZnO). The ternary metal oxide composition provides a suitable environment for the electrochemical oxidation of clozapine molecules. The ternary metal oxide composition combines the beneficial properties of Cu₂O, Y₂O₃, and ZnO, such as good thermal and chemical stability, high band gap, and low phonon frequency. These properties contribute to the enhanced electrocatalytic activity and superior conductivity of the CYZ nanostructure layer 108. In particular, the incorporation of yttrium in the ternary metal oxide structure affects structural and optical properties of the analyte sample in a way that enhances the sensing performance of the electrochemical sensor 100 for detecting clozapine therein.

In the present configuration, the CYZ nanostructure layer 108 may include nanosheets with a two-dimensional planar structure, typically exhibiting lateral dimensions on the order of micrometers and a thickness of a few nanometers. These nanosheets are oriented parallel to the surface of the gold-coated microchip 106, maximizing the surface area available for interaction with the analyte sample. The gold-coated microchip 106, serving as the working electrode 104, may be based on a silicon substrate with a thin layer of gold deposited on its surface, similar to those used in microelectronic applications. Circuit connections to the working electrode 104 are shown in FIG. 1C, connecting a power supply (middle top) and a read out line (circuit connection on right side).

In the electrochemical sensor 100, the CYZ nanostructure layer 108 is attached to the gold-coated microchip 106 using a transparent conductive binder 110. In an example, the transparent conductive binder 110 is poly(3,4-ethylenedioxythiophene) polystyrene sulfonate (PEDOT:PSS). Specifically, a Cu₂O, Y₂O₃, ZnO nanosheet (as synthesized using a wet-chemical process, discussed later in detail) is dispersed within a matrix of the transparent conductive binder 110. This creates a thin film of the CYZ nanostructure on surface of the gold-coated microchip 106. The gold-coated microchip 106 with the CYZ nanostructure is then dried in ambient conditions to form a stable layer. The resulting CYZ nanostructure layer 108 has a sheet-like morphology with nano-level distributions of the component metal oxides.

Also, as illustrated, the electrochemical sensor 100 includes a sensing window 112 located in the housing 102 over the working electrode 104. The sensing window 112 is configured to receive a liquid analyte, facilitating the introduction of the analyte sample to be analyzed for clozapine content. The sensing window 112 is positioned in the housing 102 directly above the working electrode 104, which provides a means for the liquid analyte to come into contact with the working electrode 104. This arrangement ensures that when the liquid analyte is introduced through the sensing window 112, it comes into direct contact with the active sensing surface of the working electrode 104. The sensing window 112 is dimensioned to define a sensing area of the CYZ nanostructure layer. In an example, the sensing window 112 has dimensions (in centimeter (cm)) of about 0.168 cm by 0.168 cm. Further, in the present examples, a sensing area of the CYZ nanostructure layer located over the gold-coated microchip is 0.02218 cm². Such design permits the sensing window 112 to hold a small volume of the liquid analyte, typically in the microliter range, which is sufficient for the electrochemical detection of clozapine as per the configuration of the electrochemical sensor 100. The sensing window is not limited to a square configuration, and may be any shape, such as round, oval, rectangular, and the like. Furthermore, the sensing window is not constrained to be the same size as the working electrode 104. The sensing window may be smaller or larger than the working electrode as needed to meet design requirements of the electrochemical sensor 100. In an aspect, the sensing window may be fabricated as part of a plastic housing of the electrochemical sensor 100 and have an opening which is larger than the working electrode 104 and a capillary which tapers to the size of the functionalized surface of the working electrode 104. Alternatively, the sensing window configuration may include a plurality of capillaries which distribute the analyte onto preferential regions of the CYZ nanostructure layer 108

Further, as illustrated, the electrochemical sensor 100 includes a platinum counter electrode 114 configured to be immersed in the received liquid analyte. The platinum counter electrode 114 plays a role in the electrochemical cell circuit, completing the circuit and facilitating the flow of current between the working electrode 104 and itself. The platinum counter electrode 114 is specifically chosen for use with the electrochemical sensor 100 due to its excellent electrochemical properties. Platinum is known for its stability in electrochemical systems and its ability to facilitate electron transfer reactions without interfering with the analyte detection process. The use of the platinum counter electrode 114 ensures that the electrochemical reactions occurring at the working electrode 104 can proceed efficiently. The configuration of the platinum counter electrode 114 is such that it can be easily immersed in the liquid analyte contained within the sensing window 112. This immersion ensures good electrical contact between the platinum counter electrode 114 and the electrolyte solution of the liquid analyte.

The arrangement of the working electrode 104 (with the CYZ nanostructure layer 108) and the platinum counter electrode 114 forms an electrochemical cell when the liquid analyte is introduced. This arrangement facilitates the measurement of electrical signals generated by the presence of clozapine in the liquid analyte. The combination of the CYZ nanostructure layer 108 and the platinum counter electrode 114 configures the electrochemical sensor 100 to perform measurements using various electrochemical techniques. In the present examples, an I-V (current-voltage) method is used for detecting clozapine. In this method, a potential is applied between the working electrode 104 and the platinum counter electrode 114, and the resulting current is measured. The presence and concentration of clozapine in the liquid analyte can be determined based on the characteristics of the measured current response.

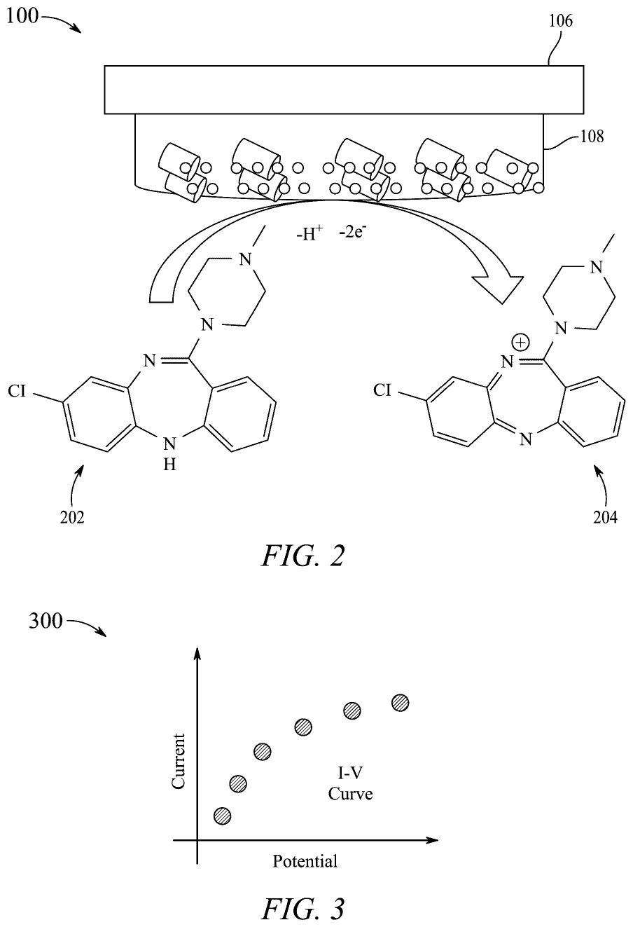

Referring to FIG. 2, illustrated is a schematic representation of the electrochemical oxidation mechanism of a clozapine molecule (as represented by reference numeral 202) at the electrochemical sensor 100. As illustrated, the electrochemical sensor 100 includes the gold-coated microchip 106, with the CYZ nanostructure layer 108 deposited thereon. The electrochemical oxidation mechanism involves interaction between the clozapine molecule 202 and the CYZ nanostructure layer 108. The clozapine molecule 202 is shown in its structural form, with its characteristic tricyclic dibenzodiazepine structure. As the clozapine molecule 202 approaches the CYZ nanostructure layer 108, it undergoes an electrochemical oxidation process. This oxidation process involves the loss of one proton (H⁺) and two electrons (2e⁻) from the clozapine molecule 202 (as indicated). This results in a change in its chemical structure to form an oxidized form of the clozapine (as represented by reference numeral 204), showing the structural changes that occur due to the loss of the proton and electrons. This oxidation process helps in the detection mechanism of the electrochemical sensor 100, as the two electrons released generate an electrical signal that is measured and analyzed to determine the presence and concentration of clozapine in the liquid analyte.

Referring to FIG. 3, illustrated is a representative current-voltage (I-V) curve 300 generated by the electrochemical sensor 100 during the detection of clozapine. The I-V curve 300 is plotted on a graph with the x-axis representing the applied potential and the y-axis representing the measured current. The I-V curve 300 shows the relationship between the potential applied to the working electrode 104 and the resulting current flow in the presence of clozapine in the liquid analyte. As the potential increases along the x-axis, there is a corresponding increase in the measured current (as shown), which is consistent with the oxidation of clozapine molecules at the surface of the CYZ nanostructure layer 108. The magnitude of the current at any given potential is proportional to the concentration of clozapine in the analyte sample, supporting quantitative analysis.

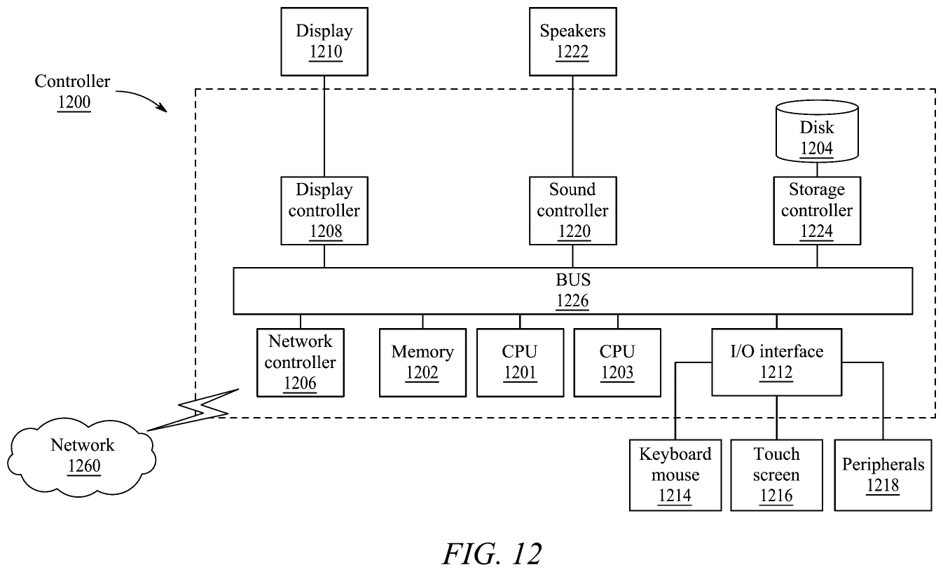

In aspects of the present disclosure, the electrochemical sensor 100 further includes a computing device 1200 (discussed later in detail in reference to FIGS. 12-15) connected to the working electrode 104 and the platinum counter electrode 114. The computing device 1200 is configured to receive an electrical signal generated by the CYZ nanostructure layer 108 between the working electrode 104 and the platinum counter electrode 114. Such electrical signal is produced when clozapine molecules in the liquid analyte interact with the CYZ nanostructure layer 108 on the working electrode 104. The computing device is responsible for processing the electrical signals generated during the clozapine detection process. As discussed in reference to FIGS. 2 and 3, when clozapine molecules come into contact with the CYZ nanostructure layer 108, they undergo a surface-mediated oxidation reaction. During this process, clozapine molecules release electrons to the conduction band of the CYZ nanostructure material, leading to a change in the electrical properties of the working electrode 104. The computing device is configured to detect when the liquid analyte contains clozapine based on the received signal. This detection is achieved through analysis of the characteristics of the electrical signal, such as changes in current or voltage that occur due to the presence of clozapine.

The computing device may also include a memory configured with a record of clozapine concentration versus a reference current and a reference voltage. The memory stores data points that correlate known clozapine concentrations with their corresponding reference current and reference voltage values. These data points may be obtained through a calibration process using standard solutions with precisely known clozapine concentrations. Thereby, the record serves as a database, supporting the computing device to correlate the measured electrical signals with specific clozapine concentrations.

The computing device is configured to measure a current and a voltage of the electrical signal, as generated by the interaction between clozapine molecules and the CYZ nanostructure layer 108. During the detection process, the computing device applies a controlled potential to the working electrode 104 and measures the resulting current flow. The computing device records these measurements, creating an I-V curve for the liquid analyte being tested (as discussed in reference to FIG. 3). The computing device is further configured to compare the electrical signal to the reference current and reference voltage to determine the concentration of clozapine in the liquid analyte. This comparison involves analyzing the characteristics of the measured I-V curve in relation to the reference current and reference voltage stored in the record of the memory. By comparing the measured electrical signal to the reference data, the computing device determines the concentration of clozapine in the liquid analyte. The computing device identifies the reference data points that most closely match the measured signal characteristics. Using these reference points, the computing device calculates the clozapine concentration through interpolation or other mathematical techniques.

The electrochemical sensor 100 also includes a display 1210 (discussed in conjunction with the computing device in reference to FIGS. 12-15) connected to the computing device. The display 1210 serves as the user interface for the electrochemical sensor 100, providing visual output of the detection results. The computing device is configured to generate a readout on the display 1210 when the liquid analyte contains clozapine. This readout may include various types of information related to the clozapine detection. In an example, the readout is configured to display a concentration of clozapine in the liquid analyte as a number of micromoles. This quantitative display of the concentration of clozapine provides precise reporting of the clozapine levels detected in the sample. The computing device calculates this concentration based on the analysis of the received electrical signals and a record of pre-determined values stored in its memory 1202. The display may also show other relevant information, such as the detection status (e.g., whether clozapine is present or not), the reliability of the measurement, or any error messages if the detection process encounters issues.

The combination of the computing device (controller 1200) and the display 1210 configures the electrochemical sensor 100 to provide rapid, quantitative results of clozapine detection. The incorporation of the computing device and the display 1210 makes the electrochemical sensor 100 particularly suitable for point-of-care applications, where rapid and accurate determination of clozapine levels is required. The arrangement and connection of these components with other components of the electrochemical sensor 100 may be contemplated by a person skilled in the art, and thus not shown and described in detail herein for brevity of the present disclosure.

For the present electrochemical sensor 100, a linear dynamic range of a detection of clozapine is 1.0 nanomoles to 1.0 micromoles (as discussed later in more detail). This linear dynamic range represents a span of clozapine concentrations over which the electrochemical sensor 100 can accurately quantify the amount of clozapine present in the liquid analyte. Within this range, the response of the electrochemical sensor 100 is directly proportional to the concentration of clozapine, facilitating reliable measurements across three orders of magnitude. This wide linear dynamic range configures the electrochemical sensor 100 to detect and quantify clozapine in samples with varying concentrations, from very low to relatively high levels, without the need for sample dilution or concentration.

Also, for the present electrochemical sensor 100, a linearity value of the linear dynamic range is 0.9993 (as discussed later in more detail). This linearity value, also known as the coefficient of determination (R2), indicates the degree to which the relationship between the measured signal and the clozapine concentration follows a linear pattern. A value of 0.9993, being very close to 1, signifies a high degree of linearity in the response of the electrochemical sensor 100. This high linearity ensures that the electrochemical sensor 100 provides consistent and reliable measurements across the entire range of detectable clozapine concentrations, from 1.0 nanomoles to 1.0 micromoles.

Further, for the present electrochemical sensor 100, a sensitivity of a detection of clozapine is 0.2146 μA μM⁻¹ cm⁻² (as discussed later in more detail). This sensitivity value represents the change in the electrical current response of the electrochemical sensor 100 per unit change in clozapine concentration, normalized to the sensing area. The units of 0.2146 μA μM⁻¹ cm⁻² indicate that for every micromole per liter increase in clozapine concentration, the electrochemical sensor 100 generates a current increase of 0.2146 microamperes per square centimeter of the sensing area. This high sensitivity supports the electrochemical sensor 100 to detect small changes in clozapine concentration, contributing to the accuracy and precision of the measurements.

Furthermore, for the present electrochemical sensor 100, a lower detection limit of clozapine in the liquid analyte is 0.04 nanomoles (as discussed later in more detail). This lower detection limit represents the smallest concentration of clozapine that can be reliably distinguished from the background noise of the measurement. At 0.04 nanomoles, the electrochemical sensor 100 can detect even very low levels of clozapine in the liquid analyte, as may be desired for applications requiring high sensitivity, such as monitoring clozapine levels in patients undergoing treatment for schizophrenia.

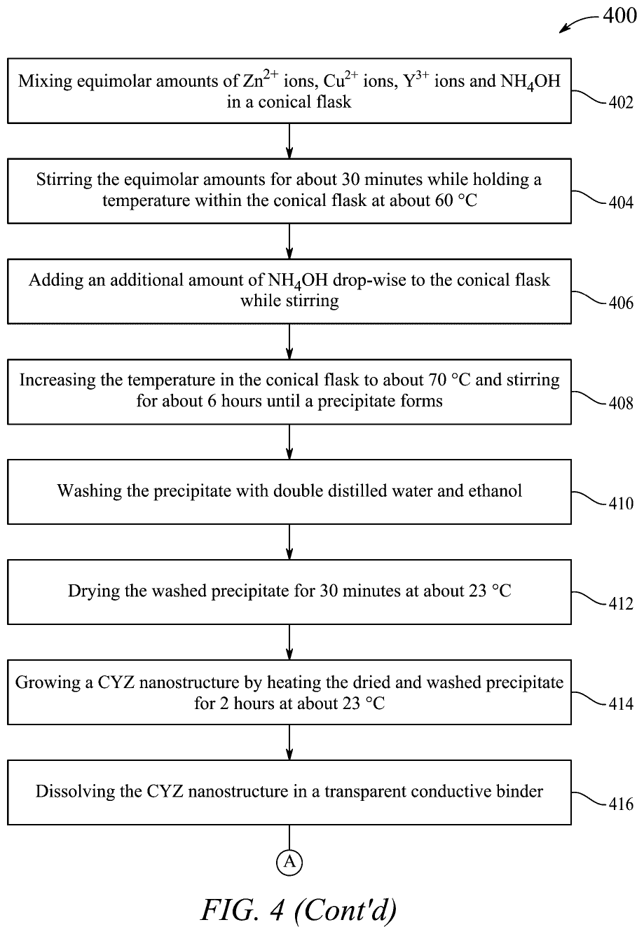

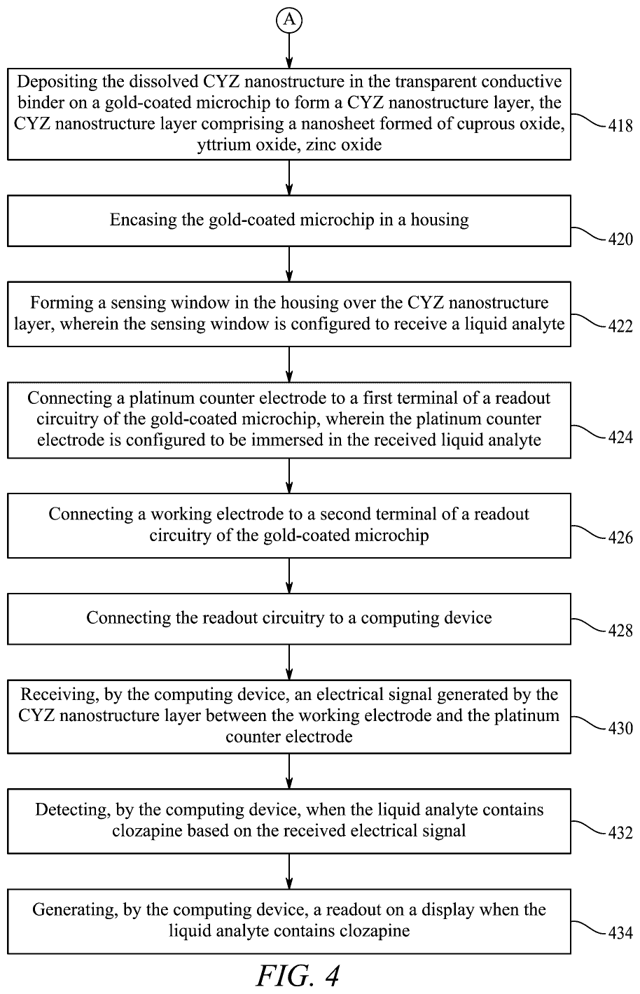

Referring to FIG. 4, the present disclosure further provides a method (as represented by a flowchart, referred by reference numeral 400) of making an electrochemical sensor (i.e., the electrochemical sensor 100) for detecting clozapine in a liquid analyte. The method 400 includes a series of steps. These steps are only illustrative, and other alternatives may be considered where one or more steps are added, one or more steps are removed, or one or more steps are provided in a different sequence without departing from the scope of the present disclosure. Various variants disclosed above, with respect to the aforementioned electrochemical sensor 100 apply mutatis mutandis to the present method 400.

At step 402, the method 400 includes mixing equimolar amounts of Zn²⁺ ions, Cu²⁺ ions, Y³⁺ ions and NH₄OH in a flask. Herein, the method 400 includes obtaining the equimolar amounts of Zn²⁺ ions, Cu²⁺ ions, Y³⁺ ions from about 50 ml of zinc oxide (ZnO), about 50 ml of cuprous oxide (Cu₂O), about 50 ml of yttrium oxide (Y₂O₃) and about 50 ml of NaOH. The equimolar amounts of each of the Zn²⁺ ions, Cu²⁺ ions, Y³⁺ ions and the NaOH equal about 0.1 M. That is, in this step, 50 ml each of 0.1 M solutions of zinc chloride (for Zn²⁺ ions), copper chloride (for Cu₂⁺ ions), and yttrium chloride (for Y³⁺ ions) are combined with 50 ml of 0.1 M ammonium hydroxide (NH₄OH) in a 500 ml conical flask. This step ensures that the required materials are present in the correct proportions for the formation of the ternary metal oxide nanostructure. The flask is not limited to a 500 ml flask or a conical structure and may be any shape or type of flask or mixing device which is able to withstand heating and is chemically inactive.

At step 404, the method 400 includes stirring the equimolar amounts for about 30 minutes while holding a temperature within the conical flask at about 60° C. This stirring and heating process promotes the initial reaction between the metal ions and the ammonium hydroxide, beginning the formation of metal hydroxide complexes. The temperature of about 60° C. is maintained using a temperature-controlled heating mantle or water bath.

At step 406, the method 400 includes adding an additional amount of NH₄OH drop-wise to the conical flask while stirring. That is, after the initial stirring period, an additional amount of NH₄OH is added drop-wise to the conical flask while stirring continues. Herein, the additional amount of NH₄OH is 200 milliliters of aqueous sodium hydroxide. Specifically, 200 ml of aqueous NH₄OH (0.1 M) is added slowly to the mixture. This drop-wise addition facilitates controlled pH adjustment and promotes the formation of the desired nanostructure. The slow addition ensures that the reaction proceeds uniformly throughout the solution.

At step 408, the method 400 includes increasing the temperature in the conical flask to about 70° C. and stirring for about 6 hours until a precipitate forms. This extended heating and stirring period at the increased temperature of about 70° C. facilitates the complete reaction of the precursors and the growth of the CYZ nanostructure. This process results in the formation of a gray precipitate which indicates the successful synthesis of the ternary metal oxide nanostructure.

At step 410, the method 400 includes washing the precipitate with double distilled water and ethanol. That is, once the precipitate has formed, it is collected and washed with double distilled water and ethanol. This washing step removes any unreacted precursors, excess NH₄OH, and other impurities that may be present in the reaction mixture. The use of double distilled water ensures high purity, while ethanol helps in removing any organic contaminants and aids in the drying process.

At step 412, the method 400 includes drying the washed precipitate for 30 minutes at about 23° C. That is, post the washing step, the washed precipitate is then dried for 30 minutes at about 23° C. (i.e., ambient temperature). This initial drying step removes excess solvents and prepares the precipitate for further processing. The ambient temperature drying helps prevent any undesired changes in the nanostructure that might occur at higher temperatures.

At step 414, the method 400 includes growing a CYZ nanostructure by heating the dried and washed precipitate for 2 hours at about 23° C. This controlled heating step at ambient conditions facilitates the formation and stabilization of the CYZ nanostructure. The relatively low temperature prevents agglomeration or excessive growth of the nanoparticles, maintaining the desired nanosheet morphology.

At step 416, the method 400 includes dissolving the CYZ nanostructure in a transparent conductive binder (such as, the transparent conductive binder 110). That is, after growing the CYZ nanostructure, the next step involves dissolving the CYZ nanostructure in the transparent conductive binder 110. In an aspect, the method 400 includes selecting the transparent conductive binder to be a poly(3,4-ethylenedioxythiophene) polystyrene sulfonate (PEDOT:PSS) binder. The PEDOT:PSS is chosen for its excellent conductivity (as well as transparency), as required for maintaining the electrochemical properties of the sensor and for efficient electron transfer.

At step 418, the method 400 includes depositing the dissolved CYZ nanostructure in the transparent conductive binder 110 on a gold-coated microchip (such as, the gold-coated microchip 106) to form a CYZ nanostructure layer (like, the CYZ nanostructure layer 108). That is, the dissolved CYZ nanostructure in the transparent conductive binder 110 is then deposited on the gold-coated microchip 106 to form the CYZ nanostructure layer 108. This deposition is typically performed using techniques such as drop-casting or spin-coating to ensure uniform coverage. The gold-coated microchip 106 serves as the substrate for a working electrode (such as, the working electrode 104). Herein, the CYZ nanostructure layer 108 includes a nanosheet formed of cuprous oxide, yttrium oxide, zinc oxide. In particular, the resulting CYZ nanostructure layer 108 includes the nanosheet formed of cuprous oxide, yttrium oxide, and zinc oxide dispersed within the PEDOT:PSS matrix. This CYZ nanostructure layer 108 is then left to dry at ambient conditions for about 1 hour to form a stable sensing layer.

At step 420, the method 400 includes encasing the gold-coated microchip 106 in a housing (such as, the housing 102). That is, the gold-coated microchip 106 with the deposited CYZ nanostructure layer 108, formed as the working electrode 104, is then encased in the housing 102. The housing 102 provides protection for the sensitive components of the electrochemical sensor 100 and gives the device its structural integrity. The housing 102 is designed to be compact, facilitating potential integration into portable devices for point-of-care applications. The housing 102 may be formed of any one of paper, plastic, metal, combinations of paper and plastic, combinations of metal and paper and/or plastic, and the like.

At step 422, the method 400 includes forming a sensing window (such as, the sensing window 112) in the housing 102 over the CYZ nanostructure layer 108. Herein, the sensing window is configured to receive a liquid analyte. This design configuration facilitates direct contact between the liquid analyte and the CYZ nanostructure layer 108. In present examples, the dimensions of the sensing window 112 are controlled to define the active sensing area to be about 0.02218 cm².

In an aspect, the method 400 includes forming the liquid analyte by mixing a phosphate buffer solution (PBS) with a biological sample. The PBS serves as an electrolyte solution that helps to maintain a stable pH environment during the electrochemical measurements. In present examples, the biological sample may include various types of bodily fluids such as blood serum, urine, or other relevant biological matrices that potentially contain clozapine. The mixing of the biological sample with PBS ensures that the liquid analyte is in a suitable form for electrochemical analysis.

At step 424, the method 400 includes connecting a platinum counter electrode (such as, the platinum counter electrode 114) to a first terminal of a readout circuitry of the gold-coated microchip 106. The connection between the platinum counter electrode 114 and the first terminal of the readout circuitry is made using a conductive wire or the like, providing a path for current flow. Herein, the platinum counter electrode 114 is configured to be immersed in the received liquid analyte. For this purpose, the platinum counter electrode 114 is positioned within the housing 102 such that when a liquid analyte is introduced through the sensing window 112, the platinum counter electrode 114 becomes immersed in the liquid analyte. This immersion establishes proper electrical contact between the platinum counter electrode 114 and the electrolyte solution formed by the liquid analyte.

At step 426, the method 400 includes connecting a working electrode (i.e., the working electrode 104) to a second terminal of a readout circuitry of the gold-coated microchip 106. In this case, the working electrode 104 corresponds to the gold-coated microchip 106 itself, which has been modified with the CYZ nanostructure layer 108 and serves as the active sensing element of the electrochemical sensor 100. The connection is made directly to the gold coating of the gold-coated microchip 106, which serves as the conductive base for the working electrode 104. This connection ensures that the electrical signals generated at the CYZ nanostructure layer 108 during the electrochemical reactions with clozapine can be effectively transmitted to the readout circuitry.

In an aspect of the present disclosure, the method 400 includes forming, by lithography, the working electrode 104 and the platinum counter electrode 114 on the gold-coated microchip 106. Lithography is a precise microfabrication technique that facilitates the accurate patterning of electrode structures on the surface of the gold-coated microchip 106. This process involves coating the gold-coated microchip 106 with a photoresist material, exposing it to light through a mask with the desired electrode pattern, and then developing the photoresist to reveal the patterned areas. The exposed gold areas form the working electrode. The platinum counter electrode 114 is then deposited onto a designated area using techniques such as sputtering or electroplating. This approach ensures precise control over the size, shape, and positioning of both the working electrode 104 and the platinum counter electrode 114 on the gold-coated microchip 106.

At step 428, the method 400 includes connecting the readout circuitry to a computing device. This connection is typically made using a data interface such as a USB port or a serial connection, depending on the specific design of the electrochemical sensor 100. The readout circuitry serves as an intermediary between the electrodes (the working electrode 104 and platinum counter electrode 114) and the computing device. The readout circuitry may include signal conditioning components such as amplifiers and analog-to-digital converters to prepare the electrical signals for processing by the computing device. This connection permits the computing device to receive the electrical signals generated during the clozapine detection process, enabling it to perform the necessary analysis and calculations to determine the presence and concentration of clozapine in the liquid analyte.

At step 430, the method 400 includes receiving, by the computing device, an electrical signal generated by the CYZ nanostructure layer 108 between the working electrode 104 and the platinum counter electrode 114. This electrical signal is produced when clozapine molecules in the liquid analyte interact with the CYZ nanostructure layer 108. The interaction involves the oxidation of clozapine molecules at the surface of the CYZ nanostructure layer 108, resulting in the transfer of electrons. This electron transfer causes a change in the electrical properties of the system, which is detected as the electrical signal. The computing device receives this signal through the readout circuitry connected to both the working electrode 104 and the platinum counter electrode 114.

At step 432, the method 400 includes detecting, by the computing device, when the liquid analyte contains clozapine based on the received electrical signal. The detection process involves analyzing the signal using pre-programmed algorithms and comparing it to the stored record of clozapine concentration versus reference current and reference voltage to interpret the received signal and determine if clozapine is present in the liquid analyte. The computing device analyzes parameters such as the magnitude of the current at specific applied potentials, the shape of the I-V curve, or the area under the I-V curve. These parameters are correlated with the presence and concentration of clozapine in the liquid analyte.

At step 434, the method 400 includes generating, by the computing device, a readout on a display when the liquid analyte contains clozapine. The readout provides visual confirmation of the detection result to the user of the electrochemical sensor 100. The readout may include various types of information, such as an indication of the presence of clozapine (e.g., “Clozapine Detected”), a quantitative measurement of the clozapine concentration in micromoles, error in the detection, and confidence level of the detection. The generation of this readout completes the clozapine detection process, providing the user with actionable information about the clozapine content of the tested liquid analyte.

The method 400 of making the electrochemical sensor 100 for detecting clozapine in a liquid analyte combines nanomaterial synthesis with microelectronic fabrication techniques to produce a highly sensitive and selective sensor. The approach provides the electrochemical sensor 100 with improved reproducibility, enhanced performance characteristics, and potential for large-scale production.

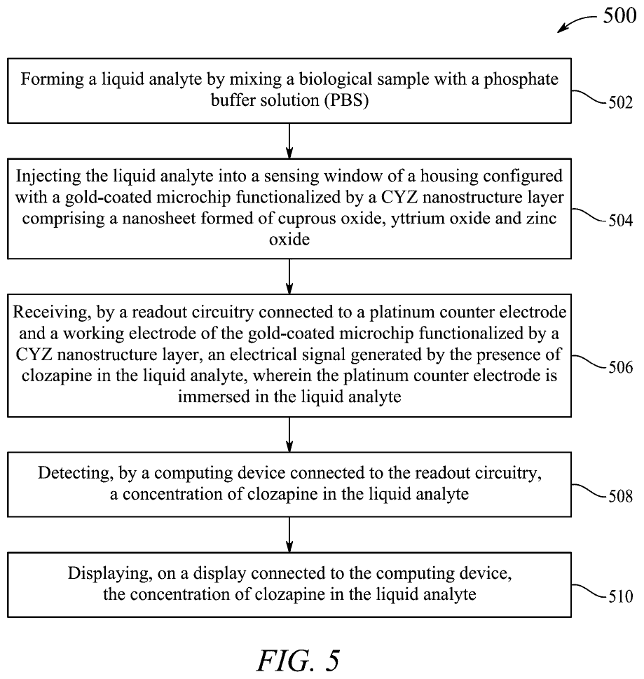

Referring to FIG. 5, the present disclosure further provides a method (as represented by a flowchart, referred by reference numeral 500) of detecting clozapine in an analyte sample. The method 500 may implement the electrochemical sensor 100 (as described in the preceding paragraphs) for this purpose. The method 500 includes a series of steps. Alternatives may be considered where one or more steps are added, one or more steps are removed, or one or more steps are provided in a different sequence without departing from the scope of the present disclosure. Various variants disclosed above, with respect to the aforementioned electrochemical sensor 100 apply mutatis mutandis to the present method 500.

At step 502, the method 500 includes forming a liquid analyte by mixing a biological sample with the phosphate buffer solution (PBS). The biological sample may be blood serum, urine, or another bodily fluid potentially containing clozapine. The PBS is added to maintain a stable pH and provide an electrolyte medium suitable for electrochemical measurements. The mixing ratio of the biological sample to PBS is carefully controlled to ensure consistent testing conditions.

At step 504, the method 500 includes injecting the liquid analyte into the sensing window 112 of the housing 102 configured with the gold-coated microchip 106 functionalized by the CYZ nanostructure layer 108 comprising a nanosheet formed of cuprous oxide, yttrium oxide and zinc oxide. Herein, the gold-coated microchip 106 serves as the working electrode 104, providing a conductive and stable surface for electrochemical reactions. The injection of the liquid analyte into the sensing window 112 brings the analyte sample into direct contact with the CYZ nanostructure layer 108, facilitates the electrochemical detection of clozapine.

At step 506, the method 500 includes receiving, by a readout circuitry connected to the platinum counter electrode 114 and the working electrode 104 of the gold-coated microchip 106 functionalized by the CYZ nanostructure layer 108, an electrical signal generated by the presence of clozapine in the liquid analyte. Herein, the platinum counter electrode 114 is immersed in the liquid analyte. When clozapine molecules in the liquid analyte come into contact with the CYZ nanostructure layer 108 on the working electrode 104, an electrochemical oxidation reaction occurs. This reaction involves the transfer of electrons from the clozapine molecules to the conduction band of the CYZ nanostructure layer 108. The electron transfer generates an electrical current, which is the electrical signal received by the readout circuitry. The platinum counter electrode 114 serves to balance the charge in the electrochemical cell and provides a reference point for measuring the electrical signal.

At step 508, the method 500 includes detecting, by the computing device 1200 (see FIG. 12) connected to the readout circuitry, a concentration of clozapine in the liquid analyte. For this purpose, the electrical signal received by the readout circuitry is processed by the computing device 1200. The computing device 1200 analyzes the characteristics of the electrical signal, such as current magnitude and voltage relationships, to detect the concentration of clozapine in the liquid analyte. This analysis involves comparing the received signal to record (pre-calibrated data) stored in the memory 1202 of the computing device 1200, which correlates specific signal patterns to known clozapine concentrations.

In particular, the method 500 includes measuring, by the computing device 1200, a current and a voltage of the electrical signal. This measurement facilitates precise quantification of the electrical signal parameters. The method 500 further includes comparing the current and the voltage of the electrical signal to a reference current and reference voltage to determine the concentration of clozapine in the liquid analyte. The reference current and reference voltage are pre-determined values stored in the memory 1202 of the computing device 1200. These reference values are established through a calibration process using known concentrations of clozapine. The comparison involves calculating the differences between the measured current and voltage and their respective reference values. The magnitude of these differences correlates with the concentration of clozapine in the liquid analyte.

At step 510, the method 500 includes displaying, on the display connected to the computing device, the concentration of clozapine in the liquid analyte. The display 1210 provides a visual readout of the clozapine concentration, typically expressed in micromoles (M). The display 1210 may also provide additional information such as detection range and sensitivity of the measurement, using the electrochemical sensor 100.

The method 500 of detecting clozapine in an analyte sample utilizes a combination of nanomaterials and microelectronics to achieve high sensitivity and selectivity in clozapine detection. The approach provides improved accuracy, lower detection limits, and faster analysis times. The method 500 is further enhanced by its simple sample preparation requirements and rapid response time, facilitating near real-time analysis. The integration of advanced signal processing algorithms in the computing device ensures reliable interpretation of the electrochemical signals, minimizing the potential for false readings.

For purposes of experimentation in the present disclosure, zinc chloride, copper chloride, yttrium chloride, ammonium hydroxide, clozapine, acetylcholine, glutathione, ascorbic acid, dopamine, lactose, tartaric acid, glycine, uric acid, sucrose, PEDOT:PSS (poly(3,4-ethylenedioxythiophene) polystyrene sulfonate), ethanol, etc., were purchased from Sigma-Aldrich and all of them were used as received. For the CYZ nanostructure, the powdered XRD prototype was recorded by the X-ray diffractometer (XRD, Thermo scientific, ARL X'TRA diffractometer). An FTIR spectrum was recorded for the CYZ nanostructure by NICOLET iS50 FTIR spectrometer, Thermo Scientific, USA). A UV-Visible spectrum was recorded by a UV/vis. spectrometer (Evolution 300 UV/visible spectrophotometer, Thermo scientific) for the CYZ nanostructure. The XPS spectra of CYZ nanostructure were recorded using an MgKa spectrometer (JEOL, JPS 9200) with an excitation radiation source (MgKa, pass energy=50.0 eV, Voltage=10 kV, Current=20 mA). The morphology of the CYZ nanostructure was studied by the FESEM (JEOL, JSM-7600F, Japan). The elemental analysis was performed by the EDS from JEOL, Japan. I-V method was used by the Keithley, 6517A Electrometer (USA) at the normal temperature.

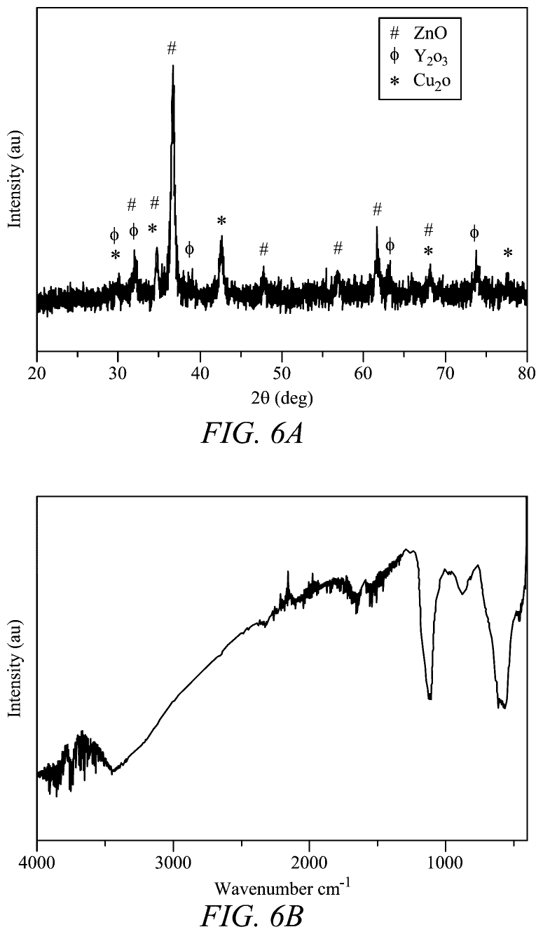

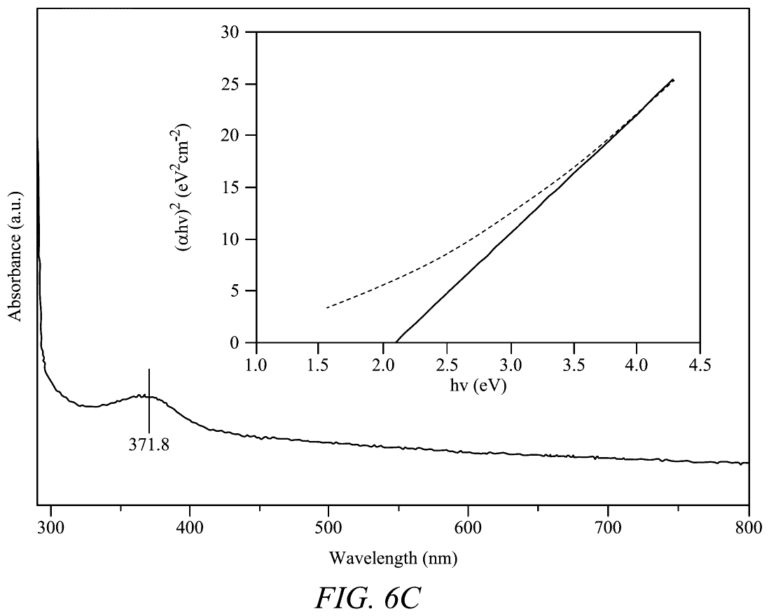

FIG. 6A illustrates a X-ray diffraction (XRD) pattern of the CYZ nanostructure. The pattern confirmed the presence of a ZnO cubic phase. Diffraction peaks were observed at 2θ values of 32.6°, 34.7°, 36.5°, 47.5°, 56.7°, 61.5°, and 68.0° can be correlated to the planes (100), (002), (101), (102), (110), (103), and (112) of the cubic ZnO (JCPDS #36-1451) [See: J. Ahmed, M. M. Rahman, L. A. Siddiquey, A. M. Asiri, M. A. Hasnat, Efficient Bisphenol—A detection based on the ternary metal oxide (TMO) composite by electrochemical approaches, Electrochim. Acta. 246 (2017) and J. Ahmed, M. M. Rahman, I. A. Siddiquey, A. M. Asiri, M. A. Hasnat, Efficient hydroquinone sensor based on zinc, strontium and nickel based ternary metal oxide (TMO) composites by differential pulse voltammetry, Sensors Actuators, B Chem. 256 (2018)]. While diffraction peaks appeared at 2θ value 29.8°, 34.7°, 42.5°, 68.0°, and 77.5° can be assigned to (110)), (111), (200), (220), and (222) planes of cubic Cu₂O respectively (JCPDS #05-0667) [See: M Kooti, L. Matouri, Fabrication of nanosized cuprous oxide using fehling's solution, Sci. Iran. 17 (2010) 73-78]. Again, diffraction peaks appeared at 28 value 29.8⁰, 31.8⁰, 38.9⁰, 63.1⁰, and 73.6⁰ can be assigned to (222), (400), (411), (444), and (800) planes of cubic Y₂03 respectively (JCPDS #88-1040) [See: H. Wang, C. Qian, Z. Yi, L. Rao, H. Liu, S. Zeng, Hydrothermal synthesis and tunable multicolor upconversion emission of cubic phase Y₂O₃ nanoparticles, Adv. Condens. Matter Phys. 2013 (2013)]. Therefore, these overall XRD patterns can be assigned to the Cu₂O·Y₂O₃·ZnO cubic crystal phase. The EDS results also showed that the as-grown CYZ consists of Zn, Cu, Y, and O. The overall XRD pattern confirms the Cu₂O·Y₂O₃·ZnO cubic crystal phase of the nanostructure layer.

FIG. 6B shows Fourier Transform Infrared (FTIR) spectrum of the CYZ nanostructure. The spectrum reveals atomic vibrations characteristic of the component metal oxides. The ZnO displays an absorption band at 571 cm⁻¹ in accordance with the metal-oxygen vibrational mode of absorption, which is just matched with literature values [See: J. Ahmed et al. (2017) and J. Ahmed et al. (2018)]. The bands at 621 and 1120 cm⁻¹ were due to the Cu—O stressing mode of vibrations in Cu₂O [See: D. Lai, T. Liu, X. Gu, Y. Chen, J. Niu, L. Yi, W. Chen, Suspension Synthesis of Surfactant-Free Cuprous Oxide Quantum Dots, J. Nanomater. 2015 (2015) and W. C. J. Ho, Q. Tay, H. Qi, Z. Huang, J. Li, Z. Chen, Photocatalytic and adsorption performances of faceted cuprous oxide (Cu2O) particles for the removal of methyl orange (MO) from aqueous media, Molecules. 22 (2017)]. The band that appeared at 564 cm⁻¹ was due to the Y—O bond in Y₂O₃[See: N. Basavegowda, K. Mishra, R. S. Thombal, K. Kaliraj, Y. R. Lee, Sonochemical Green Synthesis of Yttrium Oxide (Y2O3) Nanoparticles as a Novel Heterogeneous Catalyst for the Construction of Biologically Interesting 1,3-Thiazolidin-4-ones, Catal. Letters. 147 (2017) 2630-2639]. The two absorption bands that appeared at 3435 and 1645 cm⁻¹ belong to absorbed water molecules [See: K. Karthik, S. Dhanuskodi, C. Gobinath, S. Prabukumar, S. Sivaramakrishnan, Multifunctional properties of CdO nanostructures Synthesised through microwave assisted hydrothermal method, Mater. Res. Innov. 23 (2019) 310-318]. FIG. 6C presents the UV-Visible spectrum of the CYZ nanostructure, recorded from 300-800 nm at ambient conditions, to investigate the electro-catalytic property. UV-Visible spectroscopy is an analytical technique that measures the amount of discrete wavelengths of UV or visible light that are absorbed by or transmitted through a sample in comparison to a reference or blank sample. The UV-Visible spectrum was used to estimate the band-gap energy (E_{g}) of the CYZ nanostructure. A broad peak that appeared in the ultraviolet region 300-400 nm (as shown) can be attributed to the typical ZnO peak [See: J. Ahmed et al. (2017) and J. Ahmed et al. (2018)]. The E_{g} of the CYZ nanostructure was estimated by Tauc's equation (Eq. 1 below) [See: M. M. Rahman, J. Ahmed, A. M. Asiri, L. A. Siddiquey, M. A. Hasnat, Development of highly-sensitive hydrazine sensor based on facile CoS2-CNT nanocomposites, RSC Adv. 6 (2016), M. M. Rahman, J. Ahmed, A. M. Asiri, LA. Siddiquey, M. A. Hasnat, Development of 4-methoxyphenol chemical sensor based on NiS2-CNT nanocomposites, J. Taiwan Inst. Chem. Eng. 64 (2016) and M. M. Rahman, J. Ahmed, A. M. Asiri, A glassy carbon electrode modified with γ-Ce2S3-decorated CNT nanocomposites for uric acid sensor development: a real sample analysis, RSC Adv. 7 (2017)].

$$α h v = {A ( h v - {E}_{g} )}^{n} \qquad ( 1 )$$

where, α is the absorption coefficient, A is a constant, and n=1/2 for a direct transition semiconductor. To estimate the E_{g} for the as-grown CYZ nanostructure, a plot of (αhv)² vs. hv has been displayed in the inset of FIG. 6C. The direct E_{g} was estimated by extrapolating the straight-line segment of the Tauc's plot to a zero absorption coefficient value and obtained as ˜2.13 eV which is in good conformity with the ZnO band structure in a tri-metallic oxide [See: J. Ahmed, M. M. Rahman, LA. Siddiquey, A. M. Asiri, M. A. Hasnat, Efficient Bisphenol-A detection based on the ternary metal oxide (TMO) composite by electrochemical approaches, Electrochim. Acta. 246 (2017)].

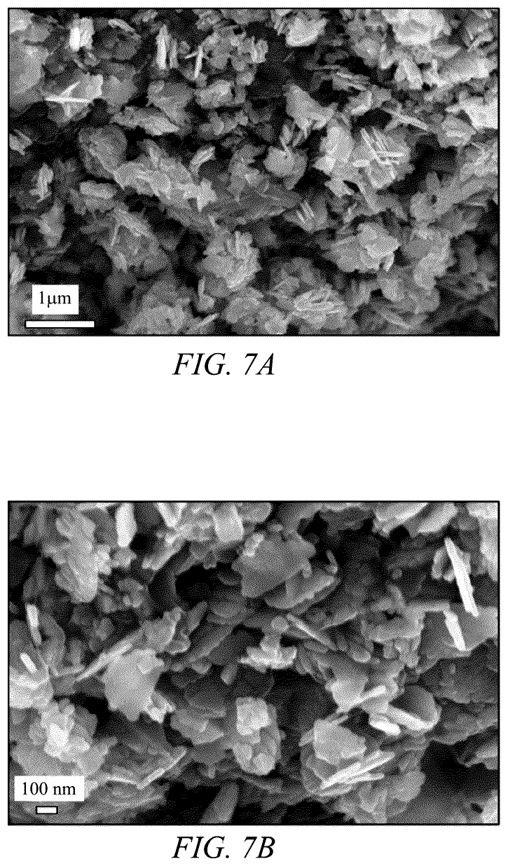

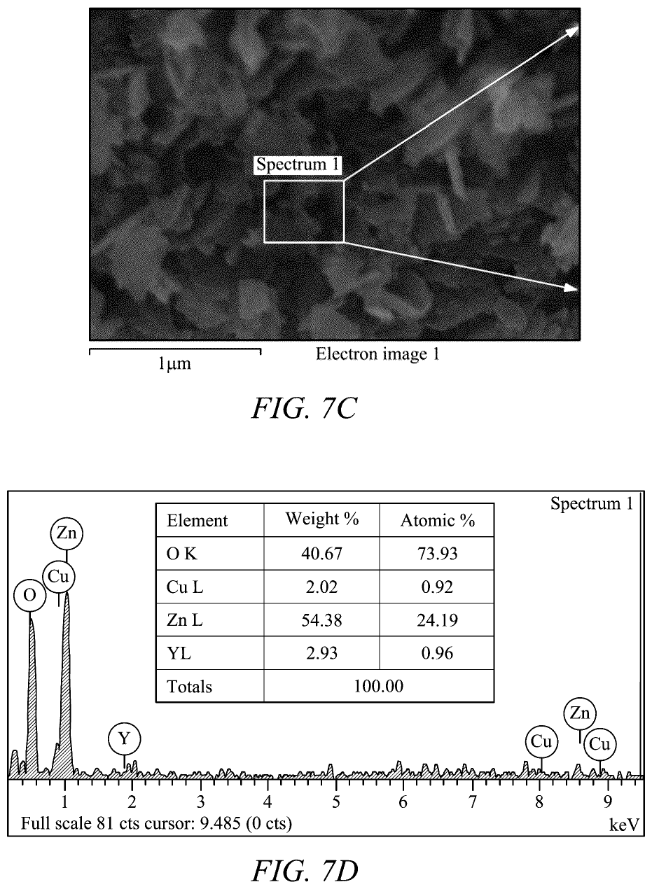

FIG. 7A is a low-resolution Field Emission Scanning Electron Microscope (FESEM) image of the CYZ nanostructure. The image shows an aggregated structure of thin sheets at the micron scale. The CYZ nanostructure appears as a collection of interconnected, irregularly shaped particles forming a porous network. This low-resolution image provides an overview of the general morphology and distribution of the CYZ nanostructure. FIG. 7B is a high-resolution FESEM image of the CYZ nanostructure. This image provides a more detailed view of the nanostructure. At this higher magnification, the thin sheet-like morphology of the CYZ nanostructure becomes more apparent. Individual nanosheets can be observed, with their edges and surfaces clearly visible. The nanosheets appear to be randomly oriented and interconnected, forming a three-dimensional network structure. FIG. 7C is an Energy-Dispersive X-ray Spectroscopy (EDS) spectrum of the CYZ nanostructure. The image shows an FESEM micrograph and indicates an area where the EDS analysis was performed. FIG. 7D is an elemental mapping derived from the EDS spectrum analysis of the CYZ nanostructure. The EDS spectrum shows peaks that represent the elemental composition of the CYZ nanostructure.

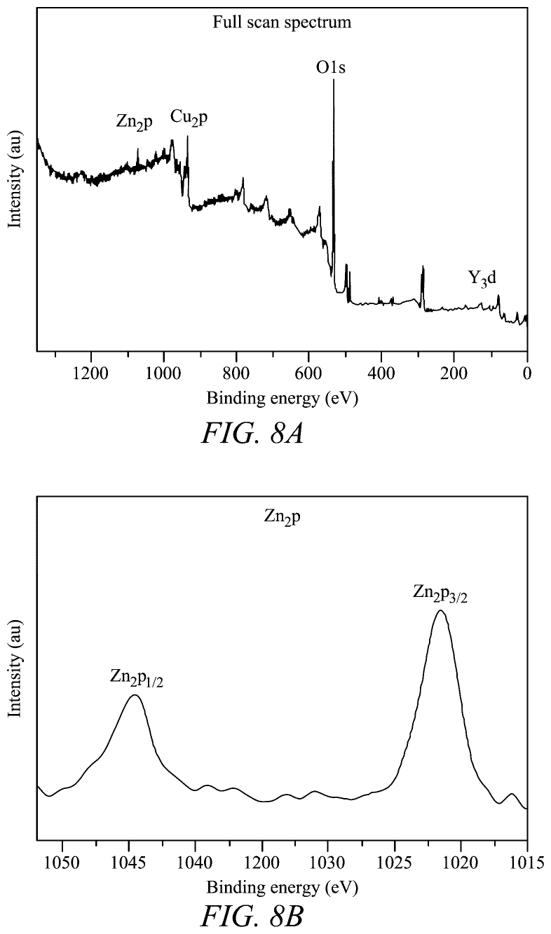

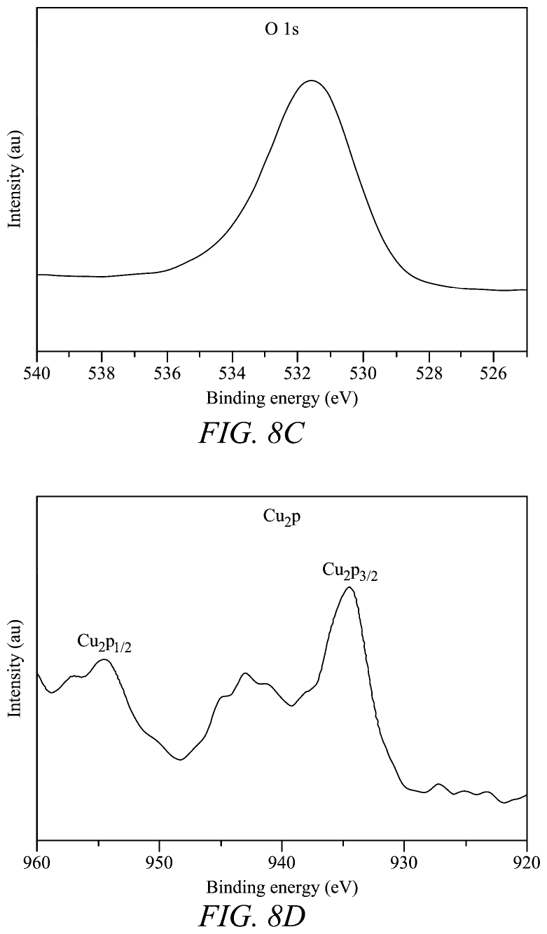

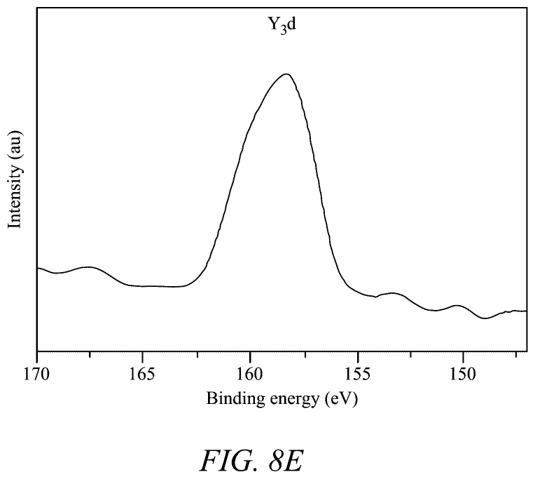

FIG. 8A is a full scan X-ray Photoelectron Spectroscopy (XPS) spectrum of the CYZ nanostructure. This spectrum represents the full scan XPS analysis that confirms the presence of Zn, Cu, Y, and O in the CYZ nanostructure. The spectrum shows distinct peaks corresponding to these elements, providing an overview of the elemental composition of the CYZ nanostructure. FIG. 8B is a fine scan XPS spectrum of Zn-2p in the CYZ nanostructure. In this Zn-2p spectrum, two prominent peaks are visible. The peak at 1021.4 eV is assigned to Zn2p3/2, while the peak at 1044.7 eV corresponds to Zn2p1/2 [See: J. Ahmed, M. M. Rahman, LA. Siddiquey, A. M. Asiri, M. A. Hasnat, Efficient hydroquinone sensor based on zinc, strontium and nickel based ternary metal oxide (TMO) composites by differential pulse voltammetry, Sensors Actuators, B Chem. 256 (2018)]. These peaks confirm the presence and chemical state of zinc in the CYZ nanostructure. FIG. 8C is a fine scan XPS spectrum of O-1s in the CYZ nanostructure. This spectrum shows one asymmetric peak at 531.5 eV, which is characteristic of the O-1s orbital [See: J. Ahmed, A. Rashed, M. Faisal, F. A. Harraz, M. Jalalah, A. Alsareii, Applied Surface Science Novel SWCNTs-mesoporous silicon nanocomposite as efficient non-enzymatic glucose biosensor, Appl. Surf Sci. 552 (2021) 149477 and J. Ahmed, M. Faisal, M. Jalalah, M. Alsaiari, S. A. Alsareii, F. A. Harraz, An efficient amperometric catechol sensor based on novel polypyrrole-carbon black doped a-Fe2O3 nanocomposite, Colloids Surfaces A Physicochem. Eng. Asp. 619 (2021) 126469]. The asymmetry of this peak may indicate the presence of different oxygen environments within the CYZ nanostructure. FIG. 8D is a fine scan XPS spectrum of Cu-2p in the CYZ nanostructure. The Cu-2p spectrum displays three peaks, where the peaks that appeared at 934.4 and 954.3 eV can be related to Cu2p3/2 and Cu2p1/2, respectively [See: D. Lai, T. Liu, X. Gu, Y. Chen, J. Niu, L. Yi, W. Chen, Suspension Synthesis of Surfactant-Free Cuprous Oxide Quantum Dots, J. Nanomater. 2015 (2015)]. These peaks provide information about the chemical state of copper in the nanostructure. FIG. 8E is a fine scan XPS spectrum of Y-3d in the CYZ nanostructure. This spectrum features a distinct peak observed at 158.3 eV, which can be attributed to the Y-3d orbital [See: Y. Chen, W. Bian, W. Huang, X. Tang, G. Zhao, L. Li, N. Li, W. Huo, J. Jia, C. You, High Critical Current Density of YBa2Cu3O7-x Superconducting Films Prepared through a DUV-assisted Solution Deposition Process, Sci. Rep. 6 (2016) 1-10]. This peak confirms the presence of yttrium in the CYZ nanostructure and provides information about its chemical environment. In general, the XPS analysis was used to obtain more information about the chemical bonds present in the CYZ nanostructure. The full scan XPS spectrum (FIG. 8A) confirms the presence of Zn, Cu, Y, and O in the nanostructure, while the fine scan XPS spectra (FIGS. 8B-8E) provide detailed information about the chemical states of these elements within the CYZ nanostructure.

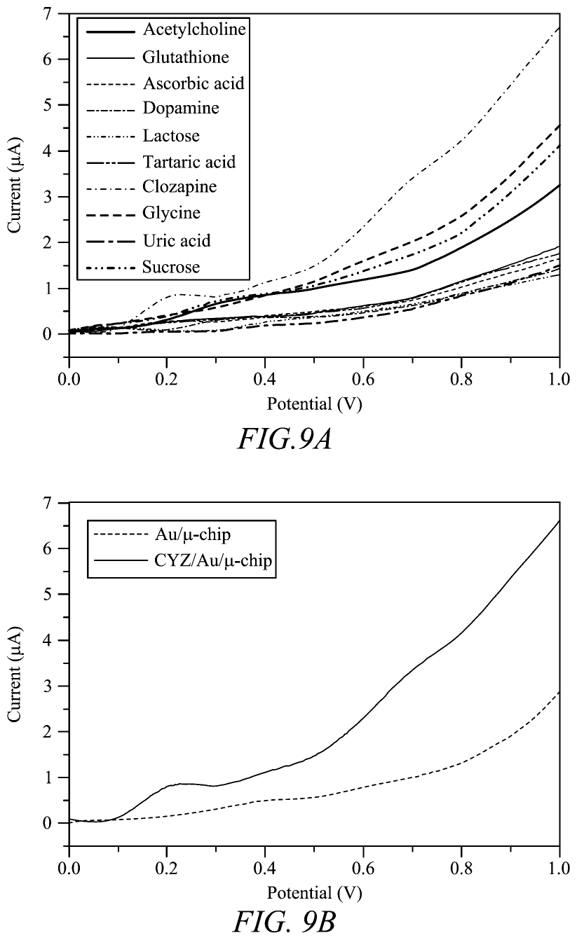

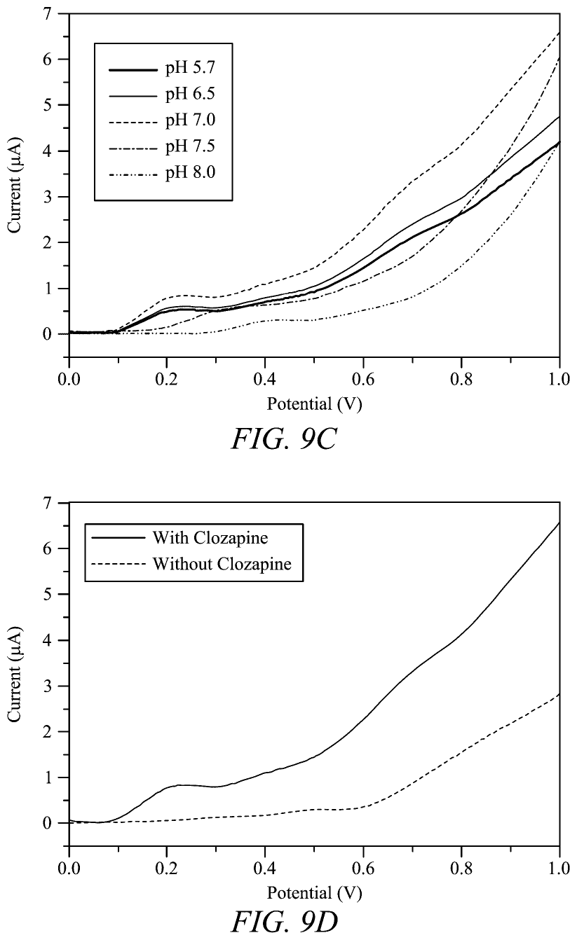

FIG. 9A is a graph illustrating a selectivity study of the electrochemical sensor 100 for clozapine detection in the presence of ten interfering chemicals. The graph displays the current responses for ten toxic interfering chemicals, where aqueous clozapine in PBS gave a distinguishably higher current response compared to other substances. This selectivity study demonstrated the ability of the electrochemical sensor 100 to distinguish clozapine from interfering agents with very close electrochemical behavior. The study was conducted using 50 μM clozapine under ambient conditions (from where we can get the highest concentrations of interfering substances that cause no more than 5% error). The results revealed that equal concentrations of acetylcholine, glutathione, ascorbic acid, dopamine, lactose, tartaric acid, glycine, uric acid, and sucrose showed a negligible effect on the current response of clozapine. This confirmed that the electrochemical sensor 100 was selective towards clozapine in the presence of these interfering chemicals.

FIG. 9B is a graph illustrating a comparison of current responses of a gold-coated microchip electrode (Au/microchip) and the electrochemical sensor 100 (CYZ/Au/microchip) for clozapine detection. The graph exhibited the current responses from 50 μM clozapine in PBS at a gold-coated microchip (dashed line) and CYZ/Au/microchip (solid line). The electrochemical sensor 100 demonstrated a considerably improved response compared to the gold-coated microchip electrode, confirming the exceptional electrochemical property of the CYZ/Au/microchip sensor towards clozapine at ambient conditions.

FIG. 9C is a graph illustrating a pH optimization study for clozapine detection using the electrochemical sensor 100. The pH effect of the electrochemical sensor 100 towards clozapine was studied for different pH values ranging from 5.7-8.0. The experiments showed that the electrochemical sensor 100 displayed very good electro-catalytic activities at various pH values. The pH effect study with clozapine revealed that at 7.0 pH (dashed line), the highest current output was observed. Consequently, pH ˜7.0 was kept constant for the rest of the experiments in clozapine detection with the electrochemical sensor 100.

FIG. 9D is a graph illustrating the current response of the electrochemical sensor 100 with and without the presence of clozapine. The graph displays the current output from the electrochemical sensor 100 with clozapine (solid line) and in the absence of clozapine (dashed line). With the presence of clozapine, a substantial upsurge of output current was obtained, which indicated the clozapine sensing ability of the electrochemical sensor 100 at ambient conditions.

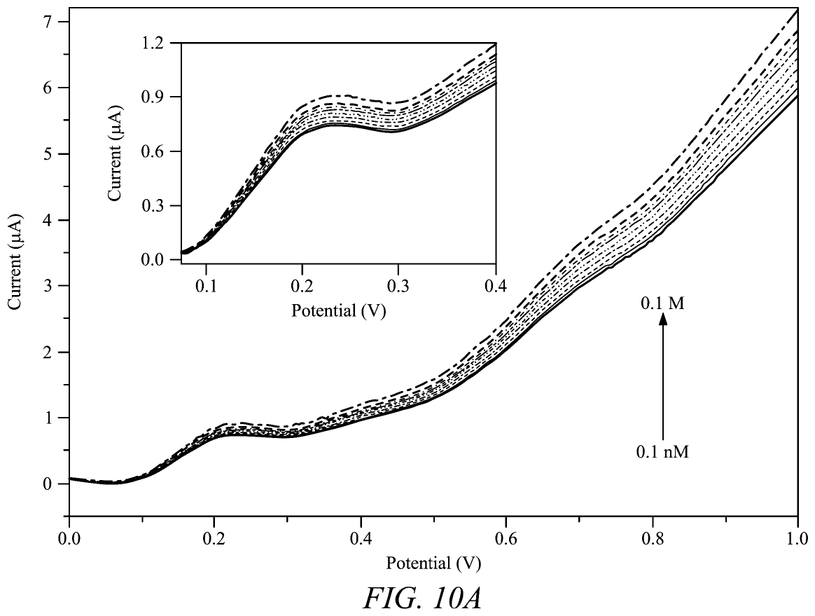

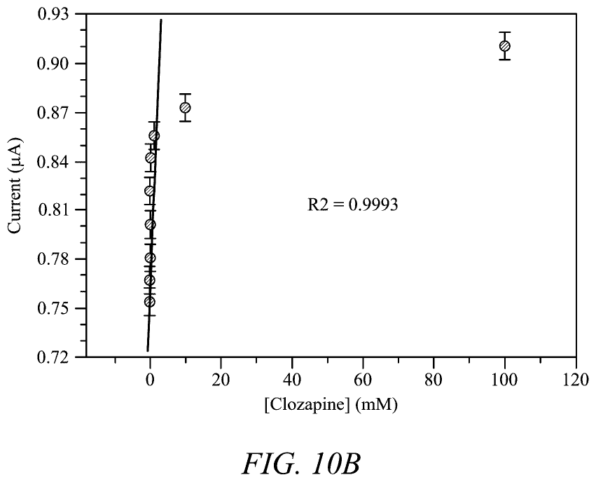

FIG. 10A is a graph illustrating the electrochemical responses of the electrochemical sensor 100 for different clozapine concentrations ranging from 1.0 nM to 0.1 M. These measurements were obtained by sequentially injecting 25 μl of clozapine (1.0 nM to 0.1 M) in 5.0 ml PBS, and then investigating the variation of current responses for each injection. The graph shows the current responses from the electrochemical sensor 100 for various clozapine concentrations. It was observed that the output current increased for the electrochemical sensor 100 with increasing clozapine concentrations. The graph demonstrates that from a lower concentration (1.0 nM) to a higher concentration (0.1 M) of clozapine, the output current rose gradually.

FIG. 10B is a graph illustrating calibration curve of the electrochemical sensor 100 for clozapine detection at +0.23 V. This calibration plot was used to determine Linear Dynamic Range (LDR) and Limit of Detection (LOD) of the newly developed clozapine sensor. As used herein, LDR indicates a range of concentrations over which the electrochemical sensor 100 provides accurate and proportional responses, whereas LOD is a measure of the lowest analyte concentration that can be detected reliably. From the calibration curve, an extremely high sensitivity value was estimated as 0.2146 μAμM⁻¹cm⁻². The LDR of the electrochemical sensor 100 was determined to be from 1.0 nM to 1.0 mM, with a linearity (R2) value of 0.9993. Additionally, an ultra-low LOD value of 0.04 nM was obtained, calculated as 3 times the noise-to-signal ratio (3×N/S). These performance metrics demonstrated the high sensitivity and wide detection range of the electrochemical sensor 100 for clozapine detection.

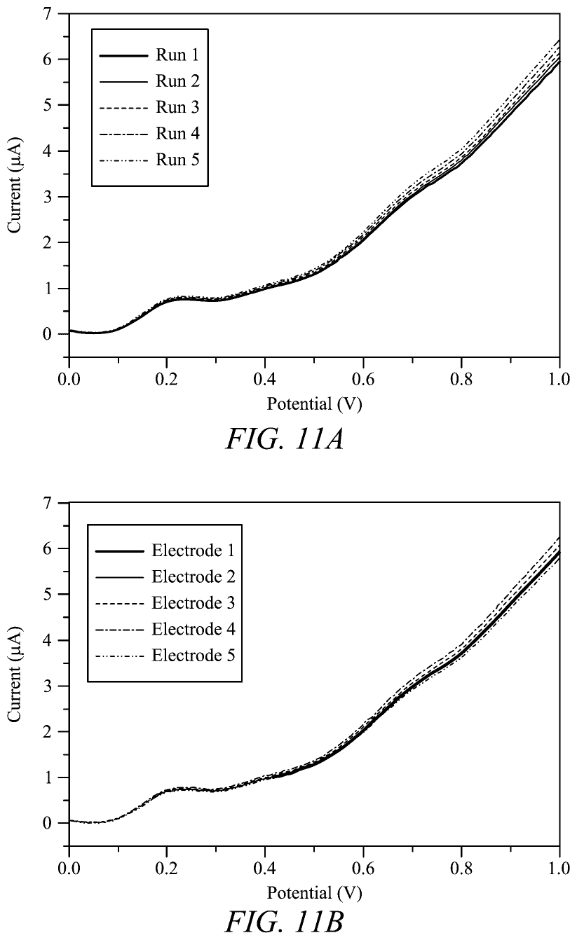

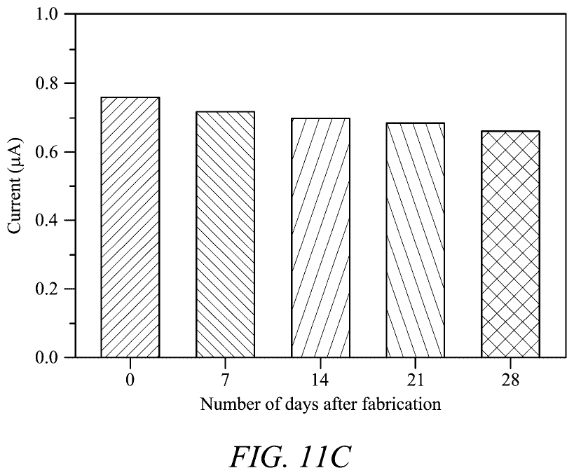

FIG. 11A is a graph illustrating repeatability of the electrochemical sensor 100 for clozapine detection. The repeatability of the electrochemical sensor 100 was tested for five successive runs in 50.0 mM clozapine. The graph shows the current responses for these repeated measurements. The results demonstrated a current variance with a relative standard deviation (RSD) of approximately 4.1%. This low RSD value indicated good repeatability of the electrochemical sensor 100 for clozapine detection.

FIG. 11B is a graph illustrating the reproducibility of the electrochemical sensor 100 for clozapine detection. The reproducibility was also assessed using five same models of electrochemical sensors 100 under identical conditions. The graph displays the current responses obtained from these different sensors. Excellent reproducibility was achieved, resulting in a relative standard deviation (RSD) of approximately 3.9%. This low RSD value demonstrated the consistent performance of the electrochemical sensor 100 across multiple devices.

FIG. 11C is a graph illustrating the stability of the electrochemical sensor 100 for clozapine detection over time. The stability of the electrochemical sensor 100 was evaluated over a period of 28 days, with the electrode stored under room conditions. The graph shows the sensitivity of the electrochemical sensor 100 over this time period. After 28 days, only a nominal decrease in sensitivity was observed, and no physical damage to the electrode was noted. The graph demonstrated the long-term stability of the electrochemical sensor 100, which is desired for its practical use in clozapine detection.

For the functionality test, the electrochemical sensor 100 was used to detect clozapine from the human blood serum, urine, and pharmaceutical clozapine tablets. Real whole blood serum and urine samples were collected from schizophrenia patients. Then these real samples were analyzed using the I-V method by the electrochemical sensor 100 as a working electrode. To this end, the standard addition method in PBS was employed to validate the correctness of the clozapine detection, as in previous reports [See: J. Ahmed et al (2017), J. Ahmed et al (2018), M. M. Rahman, J. Ahmed, A. M. Asiri, Development of Creatine sensor based on antimony-doped tin oxide (ATO) nanoparticles, Sensors Actuators, B Chem. 242 (2017), M. M. Rahman et al. (2016), M. M. Rahman (2017), incorporated herein by reference in their entirety]. Briefly, 25 μl of aqueous clozapine of various concentrations and an equal volume of real samples were mixed separately and studied in PBS using the electrochemical sensor 100. Table 1 (below) displays the results obtained, which showed that the electrochemical sensor 100 had almost 100 percent clozapine recovery.

TABLE 1
Investigation of real samples by electrochemical sensor

| | Clozapine | | Clozapine Conc. | | | |
|---|---|---|---|---|---|---|
| | Conc. | | determined by | | Recovery | RSD (%) |
| Sample | Added | | CYZ/Au/microchip | | (%) | (n = 3) |
| Blood | 50.0 | nM | 52.064 | nM | 104.1 | 3.2 |
| serum | 50.0 | μM | 52.320 | μM | 104.6 | 3.7 |
| Urine | 50.0 | nM | 49.686 | nM | 99.3 | 4.2 |
| | 50.0 | μM | 48.482 | μM | 96.9 | 3.8 |

Aqueous “Leponex 100 mg tablets” (declared content was 100 mg clozapine per tablet, manufactured by Novartis) were taken as a real clozapine sample. Three “Leponex 100 mg” tablets were dissolved in 10 ml of PBS to prepare the real clozapine solution (0.092 M). Then 200 μl of this stock solution was added to 5 ml of PBS to obtain the I-V response, and thus calculate the amount of clozapine per tablet. This clozapine determination data is presented in Table 2 (below). Furthermore, the determined value of clozapine was 98.2% of the company specification for the Leponex 100 mg tablets, demonstrating the proper validation of the electrochemical sensor 100. Therefore, it can be concluded that the electrochemical sensor 100 is acceptable, accurate, and reliable in determining clozapine in real samples.

TABLE 2
Determination of clozapine from pharmaceutical tablet sample

| | | Determined by | % RSD |
|---|---|---|---|
| Sample | Declared | CYZ/Au/microchip | n = 3 |
| Leponex | 100 mg per Tablet | 98.2 ± 0.1 mg | 3.8 |

Electrochemical responses in clozapine detection depend primarily on the size, morphology, and surface structure of the electrode material. When the surface of the CYZ nanostructure touches the clozapine, there is a surface-mediated oxidation reaction that occurred. Hence, clozapine molecules release electrons to conduction band of the CYZ nano-structured material, which ultimately increases conductance of the electrochemical sensor 100. Consequently, the electrochemical response rises. The electrochemical sensor 100 exhibited very high sensitivity in clozapine detection and extremely lower LOD than other clozapine sensors already published, including Ref 1 [See: M. Senel, A. Alachkar, Lab-in-a-pencil graphite: A 3D-printed microfluidic sensing platform for real-time measurement of antipsychotic clozapine level, Lab Chip. 21 (2021) 405-411]; Ref 2 [See: M. Senel, Z. Durmus, A. Alachkar, Measurement of the Antipsychotic Clozapine Using Reduced Graphene Oxide Nanocomposites-Au/Pd/Pt Electrodes, Electroanalysis. 33 (2021) 1585-1595]; Ref 3 [See: R. P. Shukla, C. Rapier, M. Glassman, F. Liu, D. L. Kelly, H. Ben-Yoav, An integrated electrochemical microsystem for real-time treatment monitoring of clozapine in microliter volume samples from schizophrenia patients, Electrochem. Commun. 120 (2020) 106850.]; Ref 4 [See: E. Tammari, A. Nezhadali, S. Lotfi, H. Veisi, Fabrication of an electrochemical sensor based on magnetic nanocomposite Fe3O4/β-alanine/Pd modified glassy carbon electrode for determination of nanomolar level of clozapine in biological model and pharmaceutical samples, Sensors Actuators, B Chem. 241 (2017) 879-886]; Ref 5 [See: M. R. Fathi, D. Almasifar, Electrochemical Sensor for Square Wave Voltammetric Determination of Clozapine by Glassy Carbon Electrode Modified by W03 Nanoparticles, IEEE Sens. J. 17 (2017) 6069-6076]; Ref 6 [See: N. P. Shetti, D. S. Nayak, S. J. Malode, R. M. Kulkarni, An electrochemical sensor for clozapine at ruthenium doped TiO2 nanoparticles modified electrode, Sensors Actuators, B Chem. 247 (2017) 858-867] and Ref 7 [See: S. Shahrokhian, Z. Kamalzadeh, A. Hamzehloei, Electrochemical determination of clozapine on MWCNTs/new coccine doped ppy modified GCE: An experimental design approach, Bioelectrochemistry. 90 (2013) 36-43], as in Table 3 (below). The electrochemical sensor 100 showed excellent stability and reliability in its performance.

TABLE 3
Comparison of different electrochemical sensors for clozapine detection

| | | LDR | LOD | Sensitivity | |
|---|---|---|---|---|---|
| Electrode | Method | (μM) | (nM) | (μAμM⁻¹cm⁻²) | Ref. |
| μFSE | Amp | 0.5-10 | 24 | 0.01275* | Ref 1 |
| RGO-Au/Pd/Pt | DPV | 0.05-10 | 1.6 | 9.16* | Ref 2 |
| Chitosan-CNT μE | DPV | 0.3-5.0 | 0.008 | 0.002 | Ref 3 |
| Fe₃O₄/Ala/Pd/GCE | DPV | 0.003-0.07 | 1.53 | 43* | Ref 4 |
| WO₃/GCE | SWV | 0.1-2 & | 30 | 14.524* | Ref 5 |
| | | 2-150 | | | |
| Ru—TiO₂/CPE | SWV | 0.9-40 | 0.43 | 5.714* | Ref 6 |
| MWCNTs/NC- | LSV | 0.01-5.00 | 3 | 100.055* | Ref 7 |
| PPY/GCE | | | | | |
| Electrochemical | I-V | 1.0 nM- | 0.04 | 0.2146 | Present |
| sensor | | 1.0 mM | | | disclosure |

*= μAμM⁻¹;
μFSE = pencil graphite microfluidic sensing electrode;
RGO-Au/Pd/Pt = Reduced Graphene Oxide Nanocomposites-Au/Pd/Pt Electrodes;
CNT = carbon nanotube;
μE = microelectrode;
Fe₃O₄/Ala/Pd/GCE = Fe₃O₄/alanine/Pd modified glassy carbon electrode;
Ru—TiO₂/CPE = ruthenium doped TiO2 nanoparticles;
MWCNTs/NC-PPY/GCE = MWCNTs/New Coccine doped PPY modified GCE

The electrochemical sensor 100 of the present disclosure utilizes the CYZ nanostructure layer 108 including a nanosheet of a ternary metal oxide containing cuprous oxide, yttrium oxide, and zinc oxide (Cu₂O,Y₂O₃,ZnO). The CYZ nanostructure layer 108 is deposited on the gold-coated microchip 106, forming a highly sensitive and selective working electrode 104 for clozapine detection. The integration of the CYZ nanostructure layer 108 with the platinum counter electrode 114 configures precise and reliable quantification of clozapine in various liquid analytes, including biological samples and pharmaceutical preparations.

In general, the electrochemical sensor 100 includes a sensor probe prepared with a micro-chip. The electrochemical sensor 100 is fabricated with a two-electrode configuration for performing I-V electrochemical measurements, including a working electrode (Au-round-circle) and a counter electrode (Pt-line) assembled into the micro-chip. The CYZ/Au-microchip is coated with conducting binders such as PEDOT:PSS. Formation of the CYZ nanostructure is confirmed by FTIR spectroscopy, with a characteristic peak exhibited at 571 cm⁻¹. The electrochemical sensor contains a two-electrode system in the chip-center (Au-circle) fabricated by photo-lithographic technique. The doped CYZ is composed in a round gold-white-spot onto a spike shape on the CYZ/Au-microchip sensor probe. The CYZ is successfully assembled onto the microchip as a chemical sensor probe for detecting clozapine drug molecules. The thin-sensor-surface of the CYZ/Au-microchip sensor probe is executed with conducting coating binders on the micro-chip surface.

I-V signals of the chemical sensor were estimated as a function of current versus potential for clozapine. Current responses were measured for both uncoated and coated microchip working electrodes in the absence of target clozapine, with a significant current enhancement observed with the CYZ/Au-microchip sensor probe. I-V responses were investigated for various concentrations of clozapine ranging from 0.10 nM to 0.1 M. The electrochemical sensor 100 demonstrated a large range of analyte concentration detection, with the sensitivity measured in a short response time. The LDR of the CYZ/Au-microchip sensor probe was investigated, and the sensor response time was measured to attain saturated steady-state current in the I-V curve. The modified CYZ/Au-microchip sensor probe was checked for reliability, reproducibility, and stability under ambient conditions. Selectivity performance and interference with other chemicals were measured using the I-V system. Sensor-to-sensor and run-to-run repeatability for clozapine detection was evaluated. The dynamic response of the sensor was investigated from practical concentration variation curves at room conditions. The sensitivity of the electrochemical sensor 100 was found to be 0.2146 μAμM⁻¹cm⁻², with a detection limit of 0.04 nM. The linear dynamic range was obtained as 1.0 nM-1.0 mM, with a linearity value of 0.9993 in this range. The electrochemical sensor 100 of the present disclosure introduces a well-organized route for efficient clozapine sensor development applicable to healthcare and biomedical fields on a broad scale.

The electrochemical sensor 100 of the present disclosure provides several advantages over existing methods for clozapine detection. The electrochemical sensor 100 exhibits a wide linear dynamic range of 1.0 nanomoles to 1.0 micromoles, with a high linearity value of 0.9993. This wide range supports accurate detection of clozapine across various concentration levels without the need for sample dilution or concentration. Furthermore, the electrochemical sensor 100 demonstrates a low detection limit of 0.04 nanomoles, surpassing many existing clozapine detection methods. The high sensitivity of 0.2146 μAμM⁻¹ cm⁻² aids in the detection of minute changes in clozapine concentration, making the electrochemical sensor 100 particularly suitable for therapeutic drug monitoring applications.

The electrochemical sensor 100 also offers practical advantages in terms of its design and usability. The compact housing 102 having the sensing window 112 integrated therewith, facilitates easy sample introduction and analysis. The use of the gold-coated microchip 106 as the substrate for the CYZ nanostructure layer 108 ensures excellent conductivity and stability. Additionally, the incorporation of the computing device with pre-programmed analysis algorithms and the display for readout provides user-friendly operation and immediate results. These features, combined with its stability and reliability over time, makes the electrochemical sensor 100 a useful tool in the field of clozapine detection and monitoring.

It may be appreciated that while the described aspect of the present disclosure focus on the detection of clozapine, the electrochemical sensor 100 of the present disclosure could potentially be applied to the detection of other drugs or biomarkers. Such configuration may involve modifying the composition of the CYZ nanostructure or exploring other ternary metal oxide combinations to optimize selectivity for different target analytes. Furthermore, the electrochemical sensor 100 may be integrated with other detection systems, such as optical sensing systems, to create multi-modal sensing platforms.

A first embodiment describes an electrochemical sensor 100 for detecting clozapine in an analyte sample, comprising: a housing 102; working electrode 104 located within the housing 102, wherein the working electrode 104 comprises a gold-coated microchip 106; a CYZ nanostructure layer 108 located over the gold-coated microchip 106, wherein the CYZ nanostructure layer 108 comprises a nanosheet of a ternary metal oxide containing a cuprous oxide, an yttrium oxide, and a zinc oxide (Cu₂O,Y₂O₃, ZnO); a sensing window 112 located in the housing 102 over the working electrode 104, wherein the sensing window 112 is configured to receive a liquid analyte; a platinum counter electrode 114 configured to be immersed in the received liquid analyte; a computing device connected to the working electrode 104 and the platinum counter electrode 114, wherein the computing device is configured to receive an electrical signal generated by the CYZ nanostructure layer 108 between the working electrode 104 and the platinum counter electrode 114 and detect when the liquid analyte contains clozapine based on the received signal; and a display connected to the computing device, wherein the computing device is configured to generate a readout on the display when the liquid analyte contains clozapine.

In an aspect, the readout is configured to display a concentration of clozapine in the liquid analyte as a number of micromoles.

In an aspect, the CYZ nanostructure layer 108 is attached to the gold-coated microchip 106 by a transparent conductive binder 110.

In an aspect, the transparent conductive binder 110 is poly(3,4-ethylenedioxythiophene) polystyrene sulfonate (PEDOT:PSS).

In an aspect, the Cu₂O, Y₂O₃, ZnO nanosheet is dispersed within a matrix of the transparent conductive binder 110.

In an aspect, the liquid analyte comprises a phosphate buffer solution (PBS) mixed with a biological sample.

In an aspect, a linear dynamic range of a detection of clozapine is 1.0 nanomoles to 1.0 micromoles.

In an aspect, a linearity value of the linear dynamic range is 0.9993.

In an aspect, a sensitivity of a detection of clozapine is 0.2146 μAμM⁻¹ cm².

In an aspect, a lower detection limit of clozapine in the liquid analyte is 0.04 nanomoles.

In an aspect, a sensing area of the CYZ nanostructure layer 108 located over the gold-coated microchip 106 is 0.02218 cm².

In an aspect, the computing device includes a memory configured with a record of clozapine concentration versus a reference current and a reference voltage.

In an aspect, the computing device is configured to: measure a current and a voltage of the electrical signal; and compare the electrical signal to the reference current and reference voltage to determine the concentration of clozapine in the liquid analyte.

A second embodiment describes a method 400 of making an electrochemical sensor 100 for detecting clozapine in a liquid analyte, comprising: mixing equimolar amounts of Zn²⁺ ions, Cu²⁺ ions, Y³⁺ ions and NH₄OH in a flask; stirring the equimolar amounts for about 30 minutes while holding a temperature within the flask at about 60° C.; adding an additional amount of NH₄OH drop-wise to the flask while stirring; increasing the temperature in the conical flask to about 70° C. and stirring for about 6 hours until a precipitate forms; washing the precipitate with double distilled water and ethanol; drying the washed precipitate for 30 minutes at about 23° C.; growing a CYZ nanostructure by heating the dried and washed precipitate for 2 hours at about 23° C.; dissolving the CYZ nanostructure in a transparent conductive binder 110; depositing the dissolved CYZ nanostructure in the transparent conductive binder 110 on a gold-coated microchip 106 to form a CYZ nanostructure layer 108, the CYZ nanostructure layer 108 comprising a nanosheet formed of cuprous oxide, yttrium oxide, zinc oxide; encasing the gold-coated microchip 106 in a housing 102; forming a sensing window 112 in the housing 102 over the CYZ nanostructure layer 108, wherein the sensing window 112 is configured to receive a liquid analyte; connecting a platinum counter electrode 114 to a first terminal of a readout circuitry of the gold-coated microchip 106, wherein the platinum counter electrode 114 is configured to be immersed in the received liquid analyte; connecting a working electrode 104 to a second terminal of a readout circuitry of the gold-coated microchip 106; connecting the readout circuitry to a computing device; receiving, by the computing device, an electrical signal generated by the CYZ nanostructure layer 108 between the working electrode 104 and the platinum counter electrode 114; detecting, by the computing device, when the liquid analyte contains clozapine based on the received electrical signal; and generating, by the computing device, a readout on a display when the liquid analyte contains clozapine.

In an aspect, the method 400 further comprises obtaining the equimolar amounts of Zn^{2+ ions, Cu}²⁺ ions, Y³⁺ ions from about 50 ml of zinc oxide (ZnO), about 50 ml of cuprous oxide (Cu₂O), about 50 ml of yttrium oxide (Y₂O₃) and about 50 ml of NaOH, wherein the equimolar amounts of each of the Zn²⁺ ions, Cu²⁺ ions, Y³⁺ ions and the NaOH equal about 0.1 M, wherein the additional amount of NH₄OH is 200 milliliters of aqueous sodium hydroxide.

In an aspect, the method 400 further comprises selecting the transparent conductive binder 110 to be a poly(3,4-ethylenedioxythiophene) polystyrene sulfonate (PEDOT:PSS) binder.

In an aspect, the method 400 further comprises forming the liquid analyte by mixing a phosphate buffer solution (PBS) with a biological sample.

In an aspect, the method 400 further comprises forming, by lithography, the working electrode 104 and the platinum counter electrode 114 on the gold-coated microchip 106.

A third embodiment describes a method 500 of detecting clozapine in an analyte sample is described, comprising: forming a liquid analyte by mixing a biological sample with a phosphate buffer solution (PBS); injecting the liquid analyte into a sensing window 112 of a housing 102 configured with a gold-coated microchip 106 functionalized by a CYZ nanostructure layer 108 comprising a nanosheet formed of cuprous oxide, yttrium oxide and zinc oxide; receiving, by a readout circuitry connected to a platinum counter electrode 114 and a working electrode 104 of the gold-coated microchip 106 functionalized by a CYZ nanostructure layer 108, an electrical signal generated by the presence of clozapine in the liquid analyte, wherein the platinum counter electrode 114 is immersed in the liquid analyte; detecting, by a computing device connected to the readout circuitry, a concentration of clozapine in the liquid analyte; and displaying, on a display connected to the computing device, the concentration of clozapine in the liquid analyte.

In an aspect, the method 500 further comprises measuring, by the computing device, a current and a voltage of the electrical signal; and comparing the current and the voltage of the electrical signal to a reference current and reference voltage to determine the concentration of clozapine in the liquid analyte.

Next, further details of the hardware description of a computing environment according to exemplary embodiments is described with reference to FIG. 12. In FIG. 12, a controller 1200 is described is representative of the computer device of the electrochemical sensor 100, in which the controller 1200 is a computing device which includes a CPU 1201 which performs the processes described above/below. The process data and instructions may be stored in memory 1202. These processes and instructions may also be stored on a storage medium disk 1204 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1201, 1203 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 1201 or CPU 1203 may be a Xenon or Core processor from Intel of America or an Opteron processor from AMD of America, or may be other processor types that would be recognized by one of ordinary skill in the art. Alternatively, the CPU 1201, 1203 may be implemented on an FPGA, ASIC, PLD or using discrete logic circuits, as one of ordinary skill in the art would recognize. Further, CPU 1201, 1203 may be implemented as multiple processors cooperatively working in parallel to perform the instructions of the inventive processes described above.

The computing device in FIG. 12 also includes a network controller 1206, such as an Intel Ethernet PRO network interface card from Intel Corporation of America, for interfacing with network 1260. As can be appreciated, the network 1260 can be a public network, such as the Internet, or a private network such as an LAN or WAN network, or any combination thereof and can also include PSTN or ISDN sub-networks. The network 1260 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1208, such as a NVIDIA GeForce GTX or Quadro graphics adaptor from NVIDIA Corporation of America for interfacing with display 1210, such as a Hewlett Packard HPL2445w LCD monitor. A general purpose I/O interface 1212 interfaces with a keyboard and/or mouse 1214 as well as a touch screen panel 1216 on or separate from display 1210. General purpose I/O interface also connects to a variety of peripherals 1218 including printers and scanners, such as an OfficeJet or DeskJet from Hewlett Packard.

A sound controller 1220 is also provided in the computing device such as Sound Blaster X-Fi Titanium from Creative, to interface with speakers/microphone 1222 thereby providing sounds and/or music.

The general purpose storage controller 1224 connects the storage medium disk 1204 with communication bus 1226, which may be an ISA, EISA, VESA, PCI, or similar, for interconnecting all of the components of the computing device. A description of the general features and functionality of the display 1210, keyboard and/or mouse 1214, as well as the display controller 1208, storage controller 1224, network controller 1206, sound controller 1220, and general purpose I/O interface 1212 is omitted herein for brevity as these features are known.

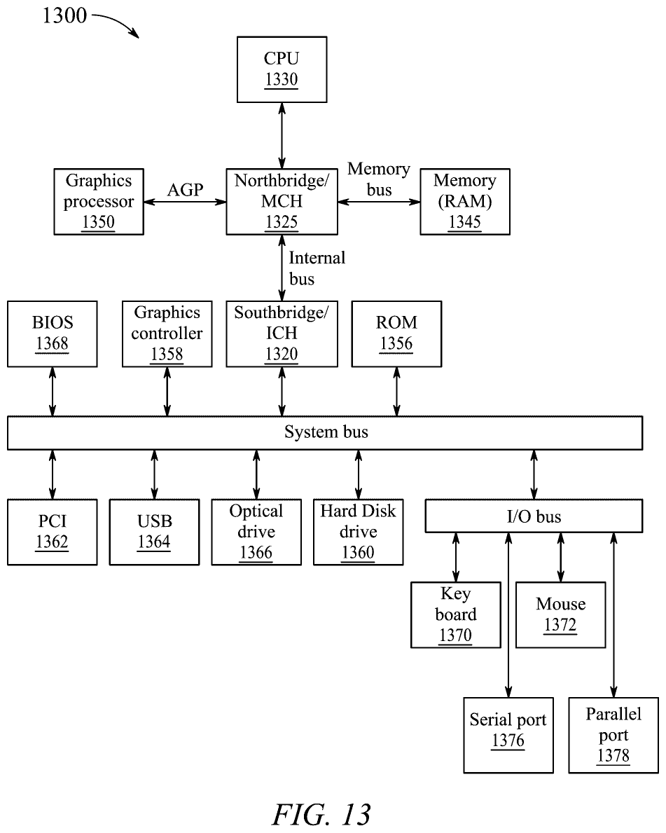

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 13.

FIG. 13 shows a schematic diagram of a data processing system, according to certain embodiments, for performing the functions of the exemplary embodiments. The data processing system is an example of a computer in which code or instructions implementing the processes of the illustrative embodiments may be located.

In FIG. 13, data processing system 1300 employs a hub architecture including a north bridge and memory controller hub (NB/MCH) 1325 and a south bridge and input/output (I/O) controller hub (SB/ICH) 1320. The central processing unit (CPU) 1330 is connected to NB/MCH 1325. The NB/MCH 1325 also connects to the memory 1345 via a memory bus, and connects to the graphics processor 1350 via an accelerated graphics port (AGP). The NB/MCH 1325 also connects to the SB/ICH 1320 via an internal bus (e.g., a unified media interface or a direct media interface). The CPU Processing unit 1330 may contain one or more processors and even may be implemented using one or more heterogeneous processor systems.

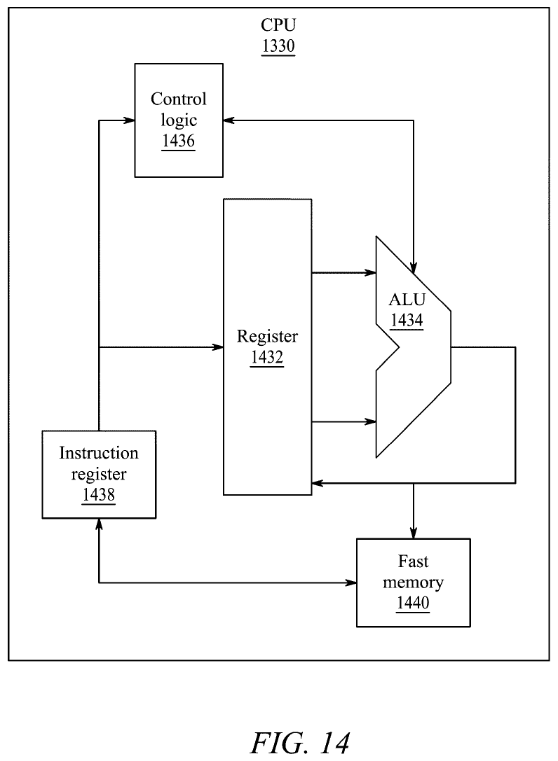

For example, FIG. 14 shows one implementation of CPU 1330. In one implementation, the instruction register 1438 retrieves instructions from the fast memory 1440. At least part of these instructions are fetched from the instruction register 1438 by the control logic 1436 and interpreted according to the instruction set architecture of the CPU 1330. Part of the instructions can also be directed to the register 1432. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1434 that loads values from the register 1432 and performs logical and mathematical operations on the loaded values according to the instructions. The results from these operations can be feedback into the register and/or stored in the fast memory 1440. According to certain implementations, the instruction set architecture of the CPU 1330 can use a reduced instruction set architecture, a complex instruction set architecture, a vector processor architecture, a very large instruction word architecture. Furthermore, the CPU 1330 can be based on the Von Neuman model or the Harvard model. The CPU 1330 can be a digital signal processor, an FPGA, an ASIC, a PLA, a PLD, or a CPLD. Further, the CPU 1330 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 13, the data processing system 1300 can include that the SB/ICH 1320 is coupled through a system bus to an I/O Bus, a read only memory (ROM) 1356, universal serial bus (USB) port 1364, a flash binary input/output system (BIOS) 1368, and a graphics controller 1358. PCI/PCIe devices can also be coupled to SB/ICH 1388 through a PCI bus 1362.

The PCI devices may include, for example, Ethernet adapters, add-in cards, and PC cards for notebook computers. The Hard disk drive 1360 and CD-ROM 1366 can use, for example, an integrated drive electronics (IDE) or serial advanced technology attachment (SATA) interface. In one implementation the I/O bus can include a super I/O (SIO) device.

Further, the hard disk drive (HDD) 1360 and optical drive 1366 can also be coupled to the SB/ICH 1320 through a system bus. In one implementation, a keyboard 1370, a mouse 1372, a parallel port 1378, and a serial port 1376 can be connected to the system bus through the I/O bus. Other peripherals and devices that can be connected to the SB/ICH 1320 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

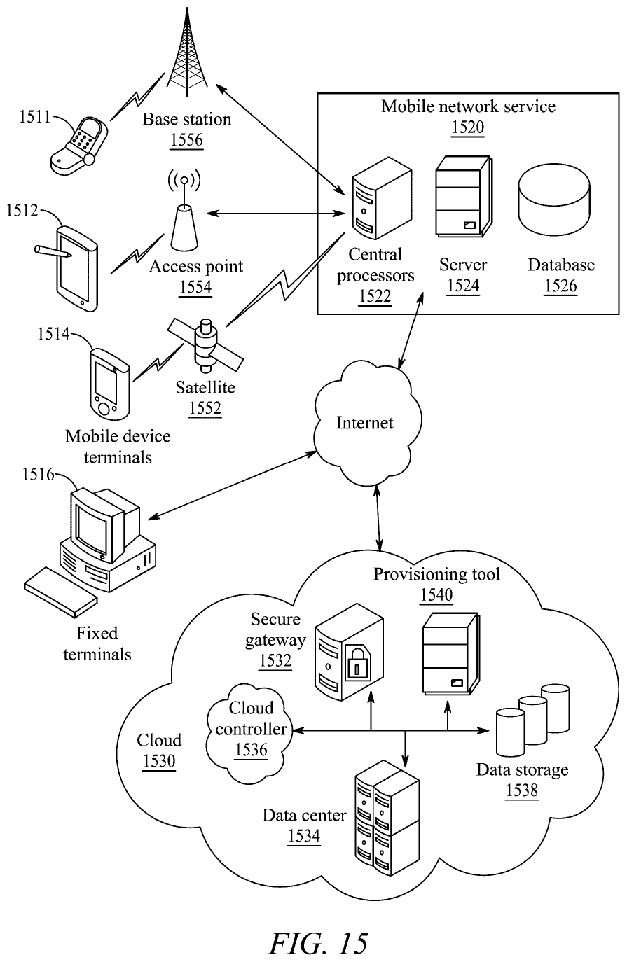

The functions and features described herein may also be executed by various distributed components of a system. For example, one or more processors may execute these system functions, wherein the processors are distributed across multiple components communicating in a network. The distributed components may include one or more client and server machines, such as cloud 1530 including a cloud controller 1536, a secure gateway 1532, a data center 1534, data storage 1538 and a provisioning tool 1540, and mobile network services 1520 including central processors 1522, a server 1524 and a database 1526, which may share processing, as shown by FIG. 15, in addition to various human interface and communication devices (e.g., display monitors 1516, smart phones 1510, tablets 1512, personal digital assistants (PDAs) 1514). The network may be a private network, such as a LAN, satellite 1552 or WAN 1554, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

While specific embodiments of the invention have been described, it should be understood that various modifications and alternatives may be implemented without departing from the spirit and scope of the invention. For example, different cellular automata rules or encryption algorithms could be employed, or alternative feature extraction and face recognition techniques could be integrated into the system.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. An electrochemical sensor for detecting clozapine in an analyte sample, comprising:
a housing;
working electrode located within the housing, wherein the working electrode comprises a gold-coated microchip;
a CYZ nanostructure layer located over the gold-coated microchip, wherein the CYZ nanostructure layer comprises a nanosheet of a ternary metal oxide containing a cuprous oxide, an yttrium oxide, and a zinc oxide (Cu₂O,Y₂O₃,ZnO);
a sensing window located in the housing over the working electrode, wherein the sensing window is configured to receive a liquid analyte;
a platinum counter electrode configured to be immersed in the received liquid analyte;
a computing device connected to the working electrode and the platinum counter electrode, wherein the computing device is configured to receive an electrical signal generated by the CYZ nanostructure layer between the working electrode and the platinum counter electrode and detect when the liquid analyte contains clozapine based on the received signal; and
a display connected to the computing device, wherein the computing device is configured to generate a readout on the display when the liquid analyte contains clozapine.

2. The electrochemical sensor of claim 1, wherein the readout is configured to display a concentration of clozapine in the liquid analyte as a number of micromoles.

3. The electrochemical sensor of claim 1, wherein the CYZ nanostructure layer is attached to the gold-coated microchip by a transparent conductive binder.

4. The electrochemical sensor of claim 3, wherein the transparent conductive binder is poly(3,4-ethylenedioxythiophene) polystyrene sulfonate (PEDOT:PSS).

5. The electrochemical sensor of claim 3, wherein the Cu₂O, Y₂O₃, ZnO nanosheet is dispersed within a matrix of the transparent conductive binder.

6. The electrochemical sensor of claim 1, wherein the liquid analyte comprises a phosphate buffer solution (PBS) mixed with a biological sample.

7. The electrochemical sensor of claim 1, wherein a linear dynamic range of a detection of clozapine is 1.0 nanomoles to 1.0 micromoles.

8. The electrochemical sensor of claim 7, wherein a linearity value of the linear dynamic range is 0.9993.

9. The electrochemical sensor of claim 1, wherein a sensitivity of a detection of clozapine is 0.2146 μAμM⁻¹ cm⁻².

10. The electrochemical sensor of claim 1, wherein a lower detection limit of clozapine in the liquid analyte is 0.04 nanomoles.

11. The electrochemical sensor of claim 1, wherein a sensing area of the CYZ nanostructure layer located over the gold-coated microchip is 0.02218 cm².

12. The electrochemical sensor of claim 1, wherein the computing device includes a memory configured with a record of clozapine concentration versus a reference current and a reference voltage.

13. The electrochemical sensor of claim 12, wherein the computing device is configured to:
measure a current and a voltage of the electrical signal; and
compare the electrical signal to the reference current and reference voltage to determine the concentration of clozapine in the liquid analyte.

14. A method of making an electrochemical sensor for detecting clozapine in a liquid analyte, comprising:
mixing equimolar amounts of Zn²⁺ ions, Cu²⁺ ions, Y³⁺ ions and NH₄OH in a flask;
stirring the equimolar amounts for about 30 minutes while holding a temperature within the flask at about 60° C.;
adding an additional amount of NH₄OH drop-wise to the flask while stirring;
increasing the temperature in the flask to about 70° C. and stirring for about 6 hours until a precipitate forms;
washing the precipitate with double distilled water and ethanol;
drying the washed precipitate for 30 minutes at about 23° C.;
growing a CYZ nanostructure by heating the dried and washed precipitate for 2 hours at about 23° C.;
dissolving the CYZ nanostructure in a transparent conductive binder;
depositing the dissolved CYZ nanostructure in the transparent conductive binder on a gold-coated microchip to form a CYZ nanostructure layer, the CYZ nanostructure layer comprising a nanosheet formed of cuprous oxide, yttrium oxide, zinc oxide;
encasing the gold-coated microchip in a housing;
forming a sensing window in the housing over the CYZ nanostructure layer, wherein the sensing window is configured to receive a liquid analyte;
connecting a platinum counter electrode to a first terminal of a readout circuitry of the gold-coated microchip, wherein the platinum counter electrode is configured to be immersed in the received liquid analyte;
connecting a working electrode to a second terminal of a readout circuitry of the gold-coated microchip;
connecting the readout circuitry to a computing device;
receiving, by the computing device, an electrical signal generated by the CYZ nanostructure layer between the working electrode and the platinum counter electrode;
detecting, by the computing device, when the liquid analyte contains clozapine based on the received electrical signal; and
generating, by the computing device, a readout on a display when the liquid analyte contains clozapine.

15. The method of claim 14, further comprising:
obtaining the equimolar amounts of Zn²⁺ ions, Cu²⁺ ions, Y³⁺ ions from about 50 ml of zinc oxide (ZnO), about 50 ml of cuprous oxide (Cu₂O), about 50 ml of yttrium oxide (Y₂O₃) and about 50 ml of NaOH, wherein the equimolar amounts of each of the Zn²⁺ ions, Cu²⁺ ions, Y³⁺ ions and the NaOH equal about 0.1 M, wherein the additional amount of NH₄OH is 200 milliliters of aqueous sodium hydroxide.

16. The method of claim 14, further comprising:
selecting the transparent conductive binder to be a poly(3,4-ethylenedioxythiophene) polystyrene sulfonate (PEDOT:PSS) binder.

17. The method of claim 14, further comprising:
forming the liquid analyte by mixing a phosphate buffer solution (PBS) with a biological sample.

18. The method of claim 14, further comprising:
forming, by lithography, the working electrode and the platinum counter electrode on the gold-coated microchip.

19. A method of detecting clozapine in an analyte sample, comprising:
forming a liquid analyte by mixing a biological sample with a phosphate buffer solution (PBS);
injecting the liquid analyte into a sensing window of a housing configured with a gold-coated microchip functionalized by a CYZ nanostructure layer comprising a nanosheet formed of cuprous oxide, yttrium oxide and zinc oxide;
receiving, by a readout circuitry connected to a platinum counter electrode and a working electrode of the gold-coated microchip functionalized by a CYZ nanostructure layer, an electrical signal generated by the presence of clozapine in the liquid analyte, wherein the platinum counter electrode is immersed in the liquid analyte;
detecting, by a computing device connected to the readout circuitry, a concentration of clozapine in the liquid analyte; and
displaying, on a display connected to the computing device, the concentration of clozapine in the liquid analyte.

20. The method of claim 19, further comprising:
measuring, by the computing device, a current and a voltage of the electrical signal; and
comparing the current and the voltage of the electrical signal to a reference current and reference voltage to determine the concentration of clozapine in the liquid analyte.
